(19) United States
(12) Patent Application Publication
(10) Pub. No.: US 2025/0324146 A1
(43) Pub. Date: Oct. 16, 2025

(54) TERMINAL, SYSTEM, AND METHOD FOR RECEIVING COMMUNICATION DATA FOR MEDIA CONTENT GENERATION

(71) Applicant: ELECTRONICS AND TELECOMMUNICATIONS RESEARCH INSTITUTE, Daejeon (KR)

(72) Inventors: Sung-Jun AHN, Daejeon (KR); Hyun-Jeong YIM, Daejeon (KR); Sung-Ik PARK, Daejeon (KR)

(73) Assignee: ELECTRONICS AND TELECOMMUNICATIONS RESEARCH INSTITUTE, Daejeon (KR)

(21) Appl. No.: 19/175,163

(22) Filed: Apr. 10, 2025

(30) Foreign Application Priority Data
Apr. 12, 2024 (KR) 10-2024-0049257
Apr. 12, 2024 (KR) 10-2024-0049272
Apr. 1, 2025 (KR) 10-2025-0041995
Apr. 8, 2025 (KR) 10-2025-0045252

(51) Int. Cl. H04N 21/854; H04N 21/4223; H04N 21/43; H04N 21/458; H04N 21/84; H04N 21/845

(52) U.S. Cl. CPC H04N 21/854; H04N 21/4302; H04N 21/458; H04N 21/84; H04N 21/845; H04N 21/4223

(57) ABSTRACT

Disclosed herein are a transmitter, a media system, and a method for transmitting communication data for media content generation, and a terminal, a media system and a method for receiving communication data for media content generation. The transmitter may include a package formatting unit configured to format at least one Service Element (SE) into a prompt package for media content generation, and a transmission unit configured to transmit communication data including the formatted prompt package. The terminal may include a receiver configured to receive communication data including a prompt package for generating media content, and a content generator configured to generate the media content based on the received prompt package.

### CROSS REFERENCE TO RELATED APPLICATIONS

This application claims the benefit of Korean Patent Application Nos. 10-2024-0049257 and 10-2024-0049272, filed Apr. 12, 2024 and 10-2025-0041995 filed Apr. 1, 2025, and 10-2025-0045252 filed Apr. 8, 2025 which are hereby incorporated by reference in their entireties into this application.

### BACKGROUND OF THE INVENTION

### 1. Technical Field

The present disclosure relates generally to a transmitter, a media system, and a method for transmitting communication data for media content generation, and more particularly to a transmitter, a media system, and a method for transmitting communication data for media content generation, which transmit communication data for generating media content based on generative Artificial Intelligence (AI) in a broadcast receiver.

The present disclosure relates generally to a terminal, a system, and a method for receiving communication data for media content generation, and more particularly to a terminal, a system, and a method for receiving communication data for media content generation, which receive communication data for generating media content based on generative Artificial Intelligence (AI) in a broadcast receiver.

### 2. Description of the Related Art

Regarding the generation of media content based on generative Artificial Intelligence (AI), generative models of generating text, audio, image, and video content have emerged with the advancement of generative AI technology. Although the quality of outputs from the generative models is still limited, the performance of the generative models is rapidly improved. In the case of video content, following the appearance of a model that operates by receiving only text prompts, multimodal models that are capable of receiving both an image and layout have appeared. Also, it is anticipated that generative models that generate media content can emerge when current capability and future development possibility of a generation application for each modality are considered.

Semantic communication refers to a concept in which communication is performed based on the meaning of information contained in data, rather than a concept in which data subjected to source coding is mechanically modulated and transmitted. Due to the emergence of generative AI, interest in semantic communication has been reignited. With the advancement of Large Language Models (LLMs), new methods that are capable of more efficiently conveying natural language are being explored, and research into the utilization of these methods for semantic communication-based text transmission is being published. In the case of images, a conceptual approach has been published in which reconstruction on a terminal side is allowed by extracting and transmitting only information about changes in features from static images.

Looking into the concept of a prompt, a prompt refers to an instruction entered into the interface of a generative AI, serving as an input statement that guides the generative AI to generate an output.

In relation to semantic media description protocols, a protocol in which the feature of completed media content is described in the form of annotation and appended to the completed media content has been defined.

FIG. 1 is a diagram illustrating the semantic media description structure of MPEG-7.

Referring to FIG. 1, MPEG-7 is one example of media content description, and the semantic media description structure has been designed for search, classification, and management of media content. The semantic description structure defined in MPEG-7 may be represented as shown in FIG. 1. Existing semantic media description technology, which is designed for search, classification, management, etc. of completed media content, does not consider the generation of media content and is not suitable for the purpose of content generation.

### SUMMARY OF THE INVENTION

Accordingly, the present disclosure has been made keeping in mind the above problems occurring in the prior art, and an object of the present disclosure is to provide a transmitter, a media system, and a method for transmitting communication data for media content generation, which can accommodate the overall semantic source in the concept of a prompt and can present an extended definition of a prompt.

Another object of the present disclosure is to provide a transmitter, a media system, and a method for transmitting communication data for media content generation, which can embrace the input source and the format structure of a generative model-based media generator, as well as an instruction, in the concept of a prompt.

A further object of the present disclosure is to provide a transmitter, a media system, and a method for transmitting communication data for media content generation, which can concretize the functionality of media generation and stabilize the quality of generated content through structured prompts.

Yet another object of the present disclosure is to provide a transmitter, a media system, and a method for transmitting communication data for media content generation, which present the design of semantic media data to be used for generation of media content.

Still another object of the present disclosure is to provide a transmitter, a media system, and a method for transmitting communication data for media content generation, which implement a new system to replace a conventional media transmission system.

Still another object of the present disclosure is to provide a transmitter, a media system, and a method for transmitting communication data for media content generation, which configure a transmission system which allows a media content generator (content generator) at a specific location to generate content by transmitting a semantic media element, rather than a transmission system which encodes and transmits previously completed media content, as a new media transmission system that is capable of replacing the conventional system.

Still another object of the present disclosure is to provide a transmitter, a media system, and a method for transmitting communication data for media content generation, which allow a generative AI-based content generator to directly generate and output media content by transmitting a semantic media element to the generative AI-based content generator.

Still another object of the present disclosure is to provide a terminal, a system, and a method for receiving communication data for media content generation, which can accommodate the overall semantic source in the concept of a prompt and can present an extended definition of a prompt.

Still another object of the present disclosure is to provide a terminal, a system, and a method for receiving communication data for media content generation, which can embrace the input source and the format structure of a generative model-based media generator, as well as an instruction, in the concept of a prompt.

Still another object of the present disclosure is to provide a terminal, a system, and a method for receiving communication data for media content generation, which can concretize the functionality of media generation and stabilize the quality of generated content through structured prompts.

Still another object of the present disclosure is to provide a terminal, a system, and a method for receiving communication data for media content generation, which present the design of semantic media data to be used for generation of media content. Still another object of the present disclosure is to provide a terminal, a system, and a method for receiving communication data for media content generation, which implement a new system to replace a conventional media transmission system.

Still another object of the present disclosure is to provide a terminal, a system, and a method for receiving communication data for media content generation, which directly generate media content from received communication data.

Still another object of the present disclosure is to provide a terminal, a system, and a method for receiving communication data for media content generation, which allow a content generator to directly generate and output media content from received communication data.

Still another object of the present disclosure is to provide a terminal, a system, and a method for receiving communication data for media content generation, which can extend media semantics and allow the extended media semantics to function as an input element for generating media content.

A method for transmitting communication data for media content generation according to the present disclosure may include formatting at least one Service Element (SE) into a prompt package for media content generation, and transmitting communication data including the formatted prompt package.

The method for transmitting communication data for media content generation may further include processing the SE based on an input media source,
wherein the media source may include at least one of a text file, an image file, a video file, an audio file, a program file, a layout data file between objects or an application program interface (API) data file, or a combination thereof.

Here, the text file may include at least one of data indicating an instruction or a command described in the form of text, data indicating content synopsis described in the form of text, or data indicating novel content described in the form of text, or a combination thereof.

The method for transmitting communication data for media content generation may further include at least one of identification information for identifying the prompt package, type information, grade information, time management information, or presentation time schedule information of the prompt package, or location information for identifying a packet in which the prompt package is transmitted, or a combination thereof, wherein the communication data may include the additional indication information and multiple prompt packages.

The prompt package may include an input statement that is entered into the interface of generative Artificial Intelligence (AI) and allows the generative AI to generate the media content, wherein the input statement may be divided into individual stages and may be designed such that, in each stage for generating the media content, a related input statement is entered into the generative AI.

The prompt package may include a first SE and a second SE, which independently function as semantic media sources and have their own unique IDs, wherein the first SE and the second SE may be designed to be used to generate a single scene.

The prompt package may include SE additional information related to the SEs, and the SE additional information may include at least one of information describing the ID of each SE, priority information of the SE, and characteristics of the SE, timing information related to a time point at which the SE appears within the media content, relationship indication information indicating correlations between the SE and other SEs, usage indication information indicating correlations in terms of utilization and application between the SE and other SEs, or SE link information, or a combination thereof. Here, each SE may be arranged in a source-type SE, and the SE additional information may be arranged in a describer SE. The prompt package may include a Describer Element (DE) for each SE, and the SE additional information may be arranged in the DE of the corresponding SE. The SE may be arranged in a source data portion of a source-type SE, and the SE additional information may be arranged in a descriptor portion of the source-type SE.

A transmitter for transmitting communication data for media content generation according to the present disclosure may include a package formatting unit configured to format at least one Service Element (SE) into a prompt package for media content generation, and a transmission unit configured to transmit communication data including the formatted prompt package.

The package formatting unit may process the SE based on an input media source, and the media source may include at least one of a text file, an image file, a video file, an audio file, a program file, a layout data file between objects or an application program interface (API) data file, or a combination thereof. Here, the text file may include at least one of data indicating an instruction or a command described in the form of text, data indicating content synopsis described in the form of text, or data indicating novel content described in the form of text, or a combination thereof.

The package formatting unit may generate additional indication information including at least one of identification information for identifying the prompt package, type information, grade information, or presentation time schedule information of the prompt package, or location information for identifying a packet in which the prompt package is transmitted, or a combination thereof, and the communication data may include the additional indication information and a plurality of prompt packages.

The prompt package may include an input statement that is entered into the interface of generative Artificial Intelligence (AI) and allows the generative AI to generate the media content, wherein the input statement may be divided into individual stages and may be designed such that, in each stage for generating the media content, a related input statement is entered into the generative AI.

The prompt package may include a first SE and a second SE, which independently function as semantic media sources and have their own unique IDs, wherein the first SE and the second SE may be designed to be used to generate a single scene.

The prompt package may include SE additional information related to the SEs, and the SE additional information may include at least one of information describing the ID of each SE, priority information of the SE, and characteristics of the SE, timing information related to a time point at which the SE appears within the media content, relationship indication information indicating correlations between the SE and other SEs, usage indication information indicating correlations in terms of utilization and application between the SE and other SEs, or SE link information, or a combination thereof. Here, each SE may be arranged in a source-type SE, and the SE additional information may be arranged in a describer SE. The prompt package may include a Describer Element (DE) for each SE, and the SE additional information may be arranged in the DE of the corresponding SE. The SE may be arranged in a source data portion of a source-type SE, and the SE additional information may be arranged in a descriptor portion of the source-type SE.

A media system for transmitting communication data for media content generation according to the present disclosure may include a package formatting unit configured to generate at least one Service Element (SE) into a prompt package for media content generation, a transmission unit configured to output communication data including the formatted prompt package, a transport network configured to deliver the output communication data, and a front-end configured to modulate and transmit the delivered communication data.

A method for receiving communication data for media content generation according to the present disclosure may include receiving communication data including a prompt package required for generating media content, and generating media content based on the received prompt package.

The media content includes at least one of image content, audio content, a picture, text content, haptic service content, service content for providing chemicals or game service content, or a combination thereof.

Generating the media content may include generating a narrative of the media content based on the received prompt package, extracting a portion of the narrative to be converted into a scene and then generating a scene sample depicting the scene and description information of the scene sample, generating time control information based on the narrative and the scene sample, generating, from the scene sample and the description information, a storyboard including at least one of sketch information, object information, background information or layout information of the scene, or a combination thereof and a continuity book including at least one of objection motion information or camera movement information of the scene, or a combination thereof, generating a scene image from the storyboard and the continuity book, generating synchronization control information required for controlling an image sequence from the time control information, and generating an image sequence from the scene image, and then generating the media content by synchronizing the image sequence based on the synchronization control information.

The method may further include generating intermediate data for audio data from the storyboard and the continuity book, generating indication information required for controlling a length of the audio data based on the time control information, and generating audio data based on the generated intermediate data and the generated indication information.

The audio data may include at least one of a background sound, sound effects, or speech, or a combination thereof.

The method may further include processing the received prompt package into a format required for generating the media content.

The communication data may further include additional indication information including at least one of identification information for identifying the prompt package, type information, grade information, or presentation time schedule information of the prompt package, or location information for identifying a packet in which the prompt package is transmitted, or a combination thereof.

The method may further include extracting a first prompt package and a second prompt package from the communication data based on the additional indication information, wherein generating the media content may include generating a composite scene by combining a partial scene of media content generated based on the second prompt package with a partial scene of media content generated based on the first prompt package.

Generating the composite scene may include generating the composite scene based on the presentation time schedule information.

The method may further include obtaining location information of a user, acquiring content based on the location information, and editing the prompt package such that the acquired content is composited into a scene of the media content.

A terminal for receiving communication data for media content generation according to the present disclosure may include a receiver configured to receive communication data including a prompt package required for generating media content, and a content generator configured to generate the media content based on the received prompt package.

The media content may include at least one of image content, audio content, a picture, text content, haptic service content, service content for providing chemicals or game service content, or a combination thereof.

The content generator may include a narrative generation unit configured to generate a narrative of the media content based on the received prompt package, a scene sampling and description unit configured to extract a portion of the narrative to be converted into a scene and then generate a scene sample depicting the scene and description information of the scene sample, a storyboarding and continuity book generation unit configured to generate, from the scene sample and the description information, a storyboard including at least one of sketch information, object information, background information or layout information of the scene, or a combination thereof and a continuity book including at least one of objection motion information or camera movement information of the scene, or a combination thereof, a Base Scene Snapshot (BSS) generation unit configured to generate a scene image from the storyboard and the continuity book, an image media generation unit configured to generate the media content by generating an image sequence from the scene image, a time management information generation unit configured to generate time control information based on the narrative and the scene sample, and a synchronization control unit configured to generate synchronization control information required for controlling synchronization of the image sequence based on the time control information.

The terminal may further include an audio generation basic information generation unit configured to generate intermediate data for audio data from the storyboard and the continuity book and generate indication information required for controlling a length of the audio data based on the time control information, and an audio data generation unit configured to generate the audio data based on the generated intermediate data and the generated indication information.

The terminal may further include an input processing unit configured to process the received prompt package into a format that is recognizable by the content generator.

The communication data may further include additional indication information including at least one of identification information for identifying the prompt package, type information, grade information, or presentation time schedule information of the prompt package, or location information for identifying a packet in which the prompt package is transmitted, or a combination thereof.

The terminal may further include a package editing module configured to extract a first prompt package and a second prompt package from the communication data based on the additional indication information, wherein the content generator generates a composite scene by combining a partial scene of media content generated based on the second prompt package with a partial scene of media content generated based on the first prompt package.

The content generator may generate the composite scene based on the presentation time schedule information.

The terminal may further include a surrounding environment data processing unit configured to obtain location information of a user and acquire content based on the location information, wherein the package editing module edits the prompt package so that the acquired content is composited into a scene of the media content.

A media system for receiving communication data for media content generation according to the present disclosure may include a terminal configured to receive communication data including a prompt package for generating media content, and transmit a message requesting media content including the received prompt package, and a content generator configured to receive the message, generate the media content based on the prompt package included in the message, and transmit the generated media content to the terminal.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating the semantic media description structure of MPEG-7;

FIG. 2 is a configuration diagram illustrating the configuration of a conventional media transmission system;

FIG. 3 is a configuration diagram illustrating the configuration of a media system according to an embodiment of the present disclosure;

FIG. 4 is a diagram illustrating a table in which the concept of elements of a media system according to an embodiment of the present disclosure is compared with elements of the conventional media transmission system;

FIG. 5 is a diagram illustrating a prompt package structure according to an embodiment of the present disclosure;

FIG. 6 is a diagram illustrating a prompt package structure according to another embodiment of the present disclosure;

FIG. 7 is a diagram illustrating a prompt package structure according to a further embodiment of the present disclosure;

FIG. 8 is a diagram illustrating the configuration of a portion for generating a prompt package from input media sources in a media system according to an embodiment of the present disclosure;

FIG. 9 is a diagram illustrating the configuration of a content generator according to an embodiment of the present disclosure;

FIG. 10 is a diagram illustrating the configuration and output of a content generator according to an embodiment of the present disclosure;

FIG. 11 is a diagram illustrating the configuration of a content generator according to another embodiment of the present disclosure;

FIG. 12 is a diagram illustrating the configuration of a content generator according to a further embodiment of the present disclosure;

FIG. 13 is a diagram illustrating the configuration of a content generator according to yet another embodiment of the present disclosure;

FIG. 14 is a diagram illustrating a process in which BSS is generated according to an embodiment of the present disclosure;

FIG. 15 is a diagram illustrating the configuration of a terminal according to an embodiment of the present disclosure;

FIG. 16 is a diagram illustrating an operation in which a terminal according to an embodiment of the present disclosure processes multiple prompt package inputs;

FIG. 17 is a diagram for explaining a function of generating a single piece of media content from synchronized multiple prompt package inputs illustrated in FIG. 16;

FIG. 18 is a diagram illustrating the configuration of a terminal according to another embodiment of the present disclosure;

FIG. 19 is a diagram illustrating the configuration of a terminal according to a further embodiment of the present disclosure;

FIG. 20 is a diagram illustrating the configuration of a terminal according to yet another embodiment of the present disclosure;

FIG. 21 is a diagram conceptually illustrating a situation in which multiple prompt packages are asynchronously input;

FIG. 22 is a diagram illustrating the configuration of a terminal according to still another embodiment of the present disclosure;

FIG. 23 is a diagram illustrating the configuration of a terminal according to still another embodiment of the present disclosure;

FIG. 24 is a diagram illustrating the configuration of a terminal according to still another embodiment of the present disclosure;

FIG. 25 is a diagram conceptually illustrating an example in which the surrounding environment of a user appears as the background of generated image content;

FIG. 26 is a flowchart illustrating a process in which a method for transmitting communication data for media content generation is performed according to an embodiment of the present disclosure;

FIG. 27 is a flowchart illustrating a process in which a method for receiving communication data for media content generation is performed according to an embodiment of the present disclosure; and

FIG. 28 is a diagram illustrating the configuration of a computer system according to an embodiment of the present disclosure.

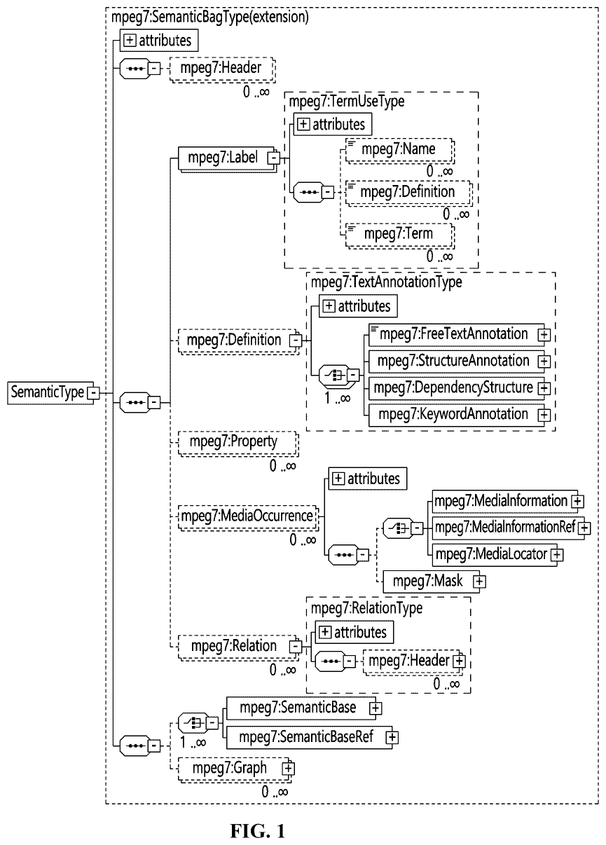

### DESCRIPTION OF THE PREFERRED EMBODIMENTS

The present disclosure may be variously modified and may have various embodiments, and thus specific embodiments will be illustrated in the attached drawings and described in detail in the detailed description of the disclosure. However, this is not intended to limit the present disclosure to particular modes of practice, and it should be appreciated that all changes, equivalents, and substitutes that do not depart from the spirit and technical scope of the present disclosure are encompassed in the present disclosure.

Detailed descriptions of example embodiments to be described later refer to the accompanying drawings illustrating a specific embodiment as an example. These embodiments are described so that those skilled in the art to which the present disclosure pertains can easily practice the embodiments. It should be understood that the various embodiments are different from each other, but are not necessarily mutually exclusive from each other. For example, specific shapes, structures, and characteristics described here may be implemented in other embodiments without departing from the spirit and scope of the present disclosure in relation to one embodiment. In addition, it should be understood that the location or arrangement of individual components within each disclosed embodiment may be changed without departing from the spirit and scope of the embodiments. Therefore, the detailed description which will be made later is not intended to be taken in a limited sense, and the scope of the example embodiments, if appropriate, is limited only by the accompanying claims, along with all the scope equivalent to those of the accompanying claims.

It should be noted that similar reference numerals in the drawings are used to designate the same or similar functions throughout various aspects. The shapes, sizes, etc. of elements in the drawings may be exaggerated to make the description clearer. Further, the term “and/or” may include a combination of a plurality of related listed items or any of the plurality of related described items. The terms “part,” “unit,” and “module” used in the present disclosure may include one or more components, and may include software components and/or hardware components.

It will be understood that, although the terms “first” and “second” may be used herein to describe various components, these components should not be limited by these terms. These terms are only used to distinguish one component from other components. For instance, a first component may be referred to as a second component without departing from the scope of the present disclosure. Similarly, the second component may also be referred to as the first component.

It should be understood that, when a certain component is described as being “connected” or “coupled” to another component, the two components may be directly connected or coupled to each other, but there may also be other components interposed between the two components. On the other hand, it should be understood that, when a certain component is referred to as being “directly connected” or “directly coupled” to another component, there are no intervening components between the two components.

The components disclosed in the embodiments are depicted independently to represent different characteristic functions, which does not imply that each component is implemented as separate hardware or a single software component. Each component is listed and included separately for convenience of explanation, but at least two of the components may be combined into a single component, or one component may be divided into multiple components to perform functions thereof. Embodiments in which components are integrated or separated are also included within the scope of the present disclosure, as long as they do not depart from the essence of the present disclosure.

The terms used in embodiments are used only to describe a specific embodiment, and are not intended to limit the present disclosure. A singular expression includes a plural expression unless a description to the contrary is specifically pointed out in context. In embodiments, it should be understood that the terms “comprise”, “include”, and “have” when used in this specification, specify the presence of stated features, integers, steps, operations, elements, components, and/or combinations of them but do not preclude the presence or addition of one or more other features, integers, steps, operations, elements, components, and/or combinations thereof. That is, in embodiments, when it is said that a specific component is “included”, it may mean that components other than the specific component are not excluded and that additional components may be included in the embodiments of the present disclosure or the scope of the technical spirit of the present disclosure.

In embodiments, the term “at least one” may denote one of numbers equal to or greater than 1, such as 1, 2, 3 and 4. In embodiments, the term “a plurality of” may denote one of numbers equal to or greater than 2, such as 2, 3 and 4.

Some components in the embodiments are not essential components that perform intrinsic functions in the present disclosure, but may merely be optional components intended to enhance performance. The embodiments may be implemented to include only the essential components necessary to realize the essence of the embodiments, excluding components used merely for performance enhancement. A structure including only the essential components, excluding optional components used merely for performance enhancement, is also included in the scope of the embodiments.

Hereinafter, embodiments of the present disclosure are described in detail with reference to the accompanying drawings so that those skilled in the art to which the present disclosure pertains can easily practice the present disclosure. In the description of the embodiments, detailed descriptions of known functions or configurations which are deemed to make the gist of the present disclosure obscure will be omitted. Further, the same reference numerals are used to designate the same or similar components throughout the drawings, and repeated descriptions of the same components will be omitted.

Hereinafter, an image may refer to one of pictures constituting video, and may also refer to video itself. For example, “image composition and/or generation” may refer to “video composition and/or generation”, and may also refer to the “composition and/or generation of one of images constituting the video”.

Hereinafter, the terms “video” and “motion picture(s)” may be used to have the same meaning, and may be used interchangeably with each other.

Hereinafter, the terms “image”, “picture”, and “frame” may be used to have the same meaning, and may be used interchangeably with each other.

The present disclosure deals with an expanded definition of a prompt, which encompasses the entire semantic source as the concept of a prompt. The present disclosure includes not only instructions, but also the input source and the format structure of a generative model-based media generator within the scope of the prompt concept. Through structured prompts, the present disclosure is intended to specify the function of media generation and to stabilize the quality of generated content.

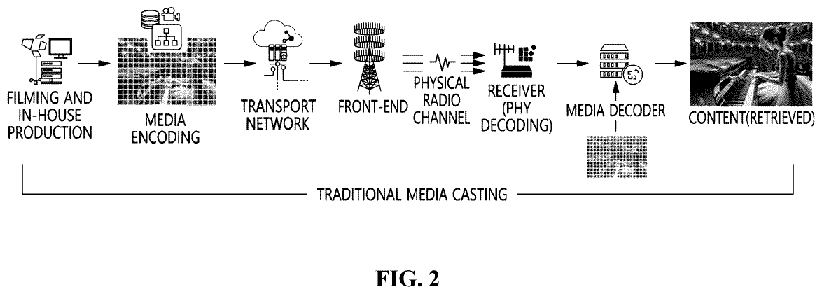

FIG. 2 is a configuration diagram illustrating the configuration of a conventional media transmission system.

Referring to FIG. 2, the present disclosure proposes the design of semantic media data used to generate mediate content, and also proposes a new system to replace a conventional media transmission system executed in the structure illustrated in FIG. 2.

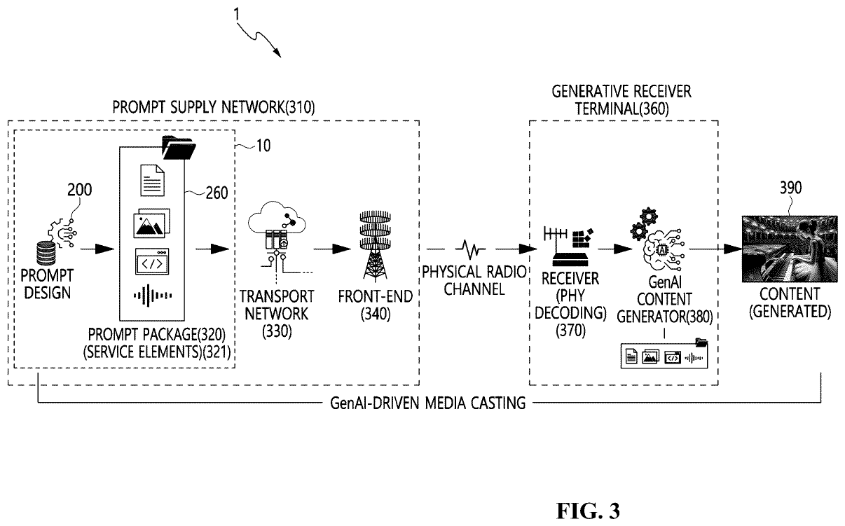

FIG. 3 is a configuration diagram illustrating the configuration of a media system according to an embodiment of the present disclosure.

Referring to FIG. 3, the present disclosure proposes a media system 1 as a new media transmission system that is capable of replacing the conventional system. The media system 1 may include a broadcasting system, a Video On Demand (VOD) system, a media generation system, and a media provision system.

The media system 1 according to the present disclosure may be a transmission system that allows a media content generator (content generator) at a specific location to generate content by transmitting a semantic media element, rather than encoding and transmitting previously completed media content.

The media system 1 according to the present disclosure may provide a media transmission system including a terminal that directly generates media content. The media system 1 according to the present disclosure may extend media semantics and allow the extended media semantics to function as an input element for generating media content.

The media system 1 according to the present disclosure may allow an AI-based content generator to directly generate and output media content by transmitting semantic media elements to the AI-based content generator.

The media system 1 according to the present disclosure may provide a new type of media transmission system that differs from the conventional media transmission system, wherein the term “conventional media transmission system” may refer to the broadcasting system illustrated in FIG. 2.

The conventional media transmission system illustrated in FIG. 2 may refer to a series of systems which (i) perform media encoding on media content having completed in its production in a studio, (ii) deliver the encoded media content to a communication network over a transport network, (iii) modulate the encoded media content into a transmission signal and transmit the transmission signal, (iv) allow a reception terminal to receive and demodulate the transmission signal, and (v) reconstruct and output the media content by performing media decoding on the demodulated transmission signal.

The above-described ‘conventional media transmission system’ may embrace a modification system derived from the above description and FIG. 2.

The media system 1 according to the present disclosure, which is a new type of media transmission system, may be a kind of Generative AI-driven Media Casting (GMC), and may be referred to as a ‘Prompt-Driven Media (PDM) system’.

The PDM system 1 according to the present disclosure may have features different from those of the conventional media transmission system. The PDM system 1 may deliver service elements to the reception terminal and allow the reception terminal to autonomously generate media content, rather than allowing the reception terminal to reconstruct pre-produced media content and a compressed and partially modified version of the pre-produced media content. Accordingly, even if the PDM system 1 is operated based on the same transmission signal, the reception terminal may output different pieces of media content. This includes the following two cases:
When different reception terminals receive the same transmission signal, respective reception terminals may output different pieces of media content.
When the same reception terminal receives the same transmission signal at different time points, the reception terminal may output different pieces of media content for respective reception instances.

The PDM system 1 may include a Prompt Serving Network (PSN) 310 and a Generative Receiver Terminal (GRT) 360. The prompt serving network 310 may include a transmitter 10, a transport network 330, and a front-end 340. The transmitter 10 may include a package formatting unit 200 and a transmission unit 260. Here, the transmitter 10 may be a broadcast transmitter.

The generative receiver terminal 360 refers to a reception terminal, and may include a receiver 370 and a generative AI-based media content generator (or generative AI-based content generator) 380.

An example of the operation of the PDM system 1 according to the present disclosure may be represented, as shown in FIG. 3. The PDM system 1 may be operated through a process in which (i) the package formatting unit 200 designs service elements 321, (ii) the transmission unit 260 delivers the service elements to a transmission network through the transport network 330, (iii) the front-end 340 modulates the service elements into a transmission signal and transmits the transmission signal, and (iv) the reception terminal 360 receives and demodulates the transmission signal, after which (v) the generative AI-based content generator 380 receives service elements associated with each other to generate media content 390, and (vi) the reception terminal 360 outputs the media content via a display.

The operation of the PDM system 1 is not limited to the description represented in FIG. 3, and may include some modifications. For example, the front-end 340 and the receiver 370, illustrated in FIG. 3, may be omitted. For example, the transmission unit 260 may transmit the designed service elements 321, with the service elements being included in an IP packet, over the Internet. For example, the content generator 380 may be installed at the edge of the transport network, and the generated media content may be encoded/modulated and then transmitted. For example, the content generator 380 may not be included in the reception terminal 360, and a content generator provided by a cloud server may be utilized. That is, the PDM system 1 according to the present disclosure refers to a media transmission system defined by a feature element for “delivering service elements to the content generator 380 and allowing the content generator 380 to autonomously generate media content 390 based on the service elements”.

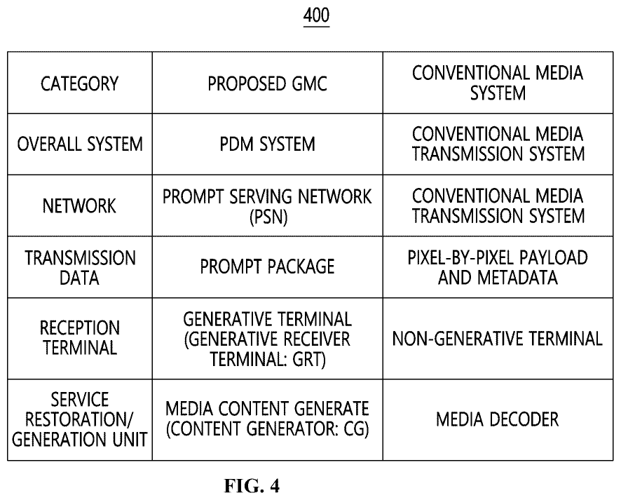

FIG. 4 is a diagram illustrating a table in which the concept of elements of a media system according to an embodiment of the present disclosure is compared with elements of the conventional media transmission system.

Referring to FIG. 4, description of the PDM system 1 according to the present disclosure and concepts represented in FIG. 3 may be described in the form of a table 400, illustrated in FIG. 4. The table 400 represents the concept of elements of the PDM system in comparison with the elements of the conventional media transmission system.

In the table 400, the Prompt Serving Network (PSN) 310 may be redefined as a delivery and transmission network in the sense that, unlike conventional technology which performs mechanical data delivery on previously completed media content on a pixel-by-pixel or bit-by-bit basis, the PSN 310 delivers and transmits service elements grouped under the concept of a “prompt package” that functions as a semantic source.

A prompt package 320 refers to a set of “service elements” functioning as semantic media sources, and detailed description thereof will be made later.

The Generative Receiver Terminal (GRT) 360 may refer to a terminal equipped with a generative AI-based media content generation function.

The media content generator (Content Generator: CG) 380 may refer to a function module or system that receives the prompt package and performs generation of media content.

In relation to the PDM system 1 according to the present disclosure, the present disclosure proposes the concept of a prompt package 320 as the invention. The prompt package 320 defined in the present disclosure refers to a set of units grouping semantic media sources that drive the PDM system 1. A single prompt package 320 may be composed of one or more service elements (SEs) 321. Each SE 321 is a data set corresponding to a unit that can independently function, and may form a subset of the prompt package 320.

The SEs 321 may be independently formatted, and each SE 321 may be formed in an independent format. For example, an image file formatted in JPEG may be processed into a single SE 321. For example, a video file formatted in High Efficiency Video Coding (HEVC) may be processed into a single SE.

The prompt package 320 is the unit of a dataset that allows the content generator (CG) to generate a single service product. A single prompt package 320 may generate a single piece of media content.

The present disclosure redefines prompts included in the prompt package 320 that drives the CG 380 to include not only text instructions but also the data formats of other modalities by broadly extending the prompts.

Each SE 321 may be configured in the format of various modalities including text, audio, pictures, motion pictures (video), layout between objects, an Application Program Interface (API), a program engine, and the like. For example, the package formatting unit 200 may configure a single SE 321 with an instruction or a command described in the form of text. The package formatting unit 200 may configure a single SE with content synopsis described in the form of text. The package formatting unit 200 may configure a single SE with social content for reference described in the form of text. The package formatting unit 200 may configure a single SE with an audio-type music file. The package formatting unit 200 may configure a single SE with an API described in the form of a program code. The package formatting unit 200 may configure a single SE with a layout indicating the locations of objects in one scene of video content that is output as the product of CG. The package formatting unit 200 may configure a single SE with a physical engine that defines physical laws applied to the motion of an object and background in video content that is output as the product of CG.

Furthermore, a single SE may also contain data having various modalities.

The prompt package 320 may take the structure of a prompt that is capable of driving the generative model in a Chain-of-Thought (CoT) manner. For example, the prompt package 320 may take a form in which an instruction/command stage is divided into multiple steps and instructions/commands to be delivered for respective stages are designed.

In the prompt package 320, each SE may have its own unique ID.

When the CG 380 utilizes information of each SE, the prompt package 320 may include SE additional information related to the SE. The SE additional information may include at least one of information describing the ID of each SE, priority information of the SE, or the characteristics of the SE, timing information related to a time point at which the SE appears within the media content, relationship indication information indicating correlations between the SE and other SEs, usage indication information indicating correlations in terms of utilization and application between the SE and other SEs, or SE link information, or a combination thereof.

Examples of the relationship indication information indicating correlations between the SE and other SEs may be taken as follows:
SEs A and B need to appear in one scene.
SE A needs to appear earlier than SE B.
SEs A and B cannot be used in the same scene.

Examples of the usage indication information indicating correlations in terms of utilization and application between the SE and other SEs may be taken as follows:
SEs A, B, and C are arranged depending on SE D indicating layouts for respective objects in a specific scene.
Object a appearing in SE A that generates a scenario is represented with reference to the shape and feature (size specification or the like) of an object appearing in SE B.
When SE A indicating an object image appears, background is generated by applying SE B indicating style.
In a specific scene, background is generated based on information associated with audio SE A or information derived from the contents of audio SE A.

The timing information included in the SE additional information may refer to information about a time point (timing management information) at which a feature generated through the utilization/application of SE data appears in generated media content. The CG 380 may be used to define and generate timestamp information for a narrative, a scenario, or a scene so that real-time presentation of the timing information included in the SE additional information is enabled.

For the case where the CG 380 selectively uses some of SEs in the prompt package 320 or other cases, the prompt package 320 may designate priorities for respective SEs, and priority information included in the SE additional information may indicate the priorities.

The prompt package 320 may describe the natures (or classification) of respective SEs. The information describing the nature of each SE included in the SE additional information may indicate the nature of the corresponding SE.

A specific SE may indicate the form and arrangement of a link through which a user can access an interactivity function in the generated media content, and a link access interface. SE link information included in the SE additional information may indicate the form and arrangement of the link or the link access interface.

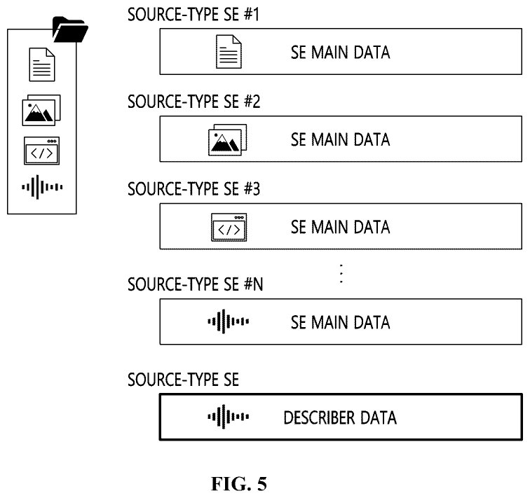

A method for describing SE additional information in the prompt package 320 may be performed using three methods, which will be described below in FIGS. 5 to 7, or using a combination of two of the three methods.

FIG. 5 is a diagram illustrating a prompt package structure according to an embodiment of the present disclosure.

Referring to FIG. 5, a first method for describing SE additional information is performed such that each SE as a media source is specified as a source-type SE and a describer SE is separately provided to identify additional information of SEs. That is, each SE may be arranged in the corresponding source-type SE, and the SE additional information may be arranged in the describer SE.

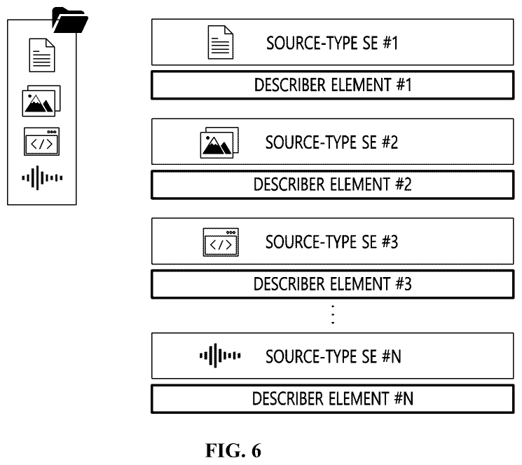

FIG. 6 is a diagram illustrating a prompt package structure according to another embodiment of the present disclosure.

Referring to FIG. 6, a second method for describing SE additional information is performed such that each SE can have a Describer Element (DE) to identify the additional information of the corresponding SE. That is, the prompt package 320 may include SEs and Describer Elements (DEs) for respective SEs, and the SE additional information may be arranged in the DE of each SE.

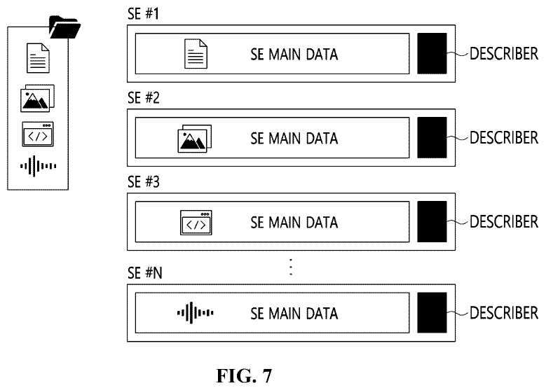

FIG. 7 is a diagram illustrating a prompt package structure according to a further embodiment of the present disclosure.

Referring to FIG. 7, a third method for describing SE additional information is implemented such that annotation-type describers referring to some portions of source data are provided within respective SEs. That is, each SE may be arranged in a source data portion of the corresponding source-type SE, and the SE additional information may be arranged in a descriptor portion of the source-type SE.

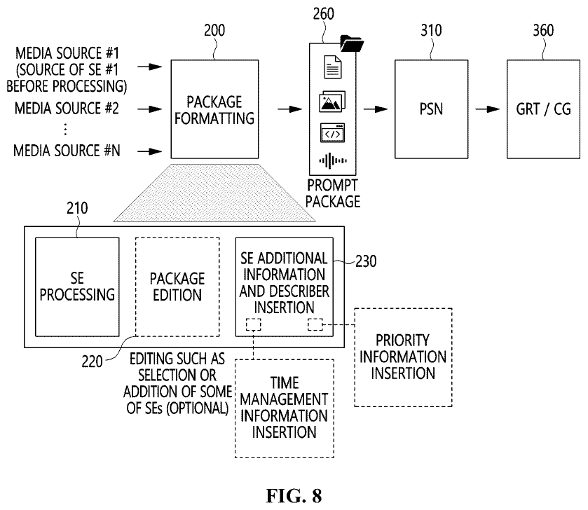

FIG. 8 is a diagram illustrating the configuration of a portion for generating a prompt package from input media sources in a media system according to an embodiment of the present disclosure.

Referring to FIG. 8, in relation to the concepts and structures of the PDM system 1 and the prompt package 320 according to the present disclosure, a system for generating the prompt package 320 from input media sources may be configured, as illustrated in FIG. 8.

The media content described in the present disclosure includes, but is not limited to, image (video) content, audio content, pictures, and text content. The media content described in the present disclosure includes a haptic service, a service for providing scents and chemicals, a game service, etc., and also takes into consideration other types of services. That is, the media content according to the present disclosure may include at least one of image (video) content, audio content, pictures, text content, haptic service content, service content for providing chemicals, or game service content, or a combination thereof.

The package formatting unit 200 may include an SE processing unit 210, a package editing module 220, and an additional information processing unit 230.

The SE processing unit 210 may process the SEs based on input media sources. Here, each media source may include at least one of a text file, an image file, a video file, an audio file, a program file, a layout data file between objects, or an application program interface (API) data file, or a combination thereof. Here, the text file may include at least one of data indicating an instruction or a command described in the form of text, data indicating content synopsis described in the form of text, or data indicating novel content described in the form of text, or a combination thereof.

The package editing module 220 may generate a prompt package including the SEs processed by the SE processing unit 210. The package editing module 220 may generate the prompt package by sorting and selecting some of SEs processed by the SE processing unit 210 and adding SEs, and may process the generated prompt package. The package editing module 220 may generate the prompt package in the structures of FIGS. 5 to 7.

The additional information processing unit 230 may insert SE additional information into the prompt package generated by the package editing module 220.

The additional information processing unit 230 may generate communication data including one or more prompt packages and additional indication information. Here, the additional indication information may include at least one of identification information for identifying each prompt package, type information, grade information, time management information, or presentation time schedule information of the prompt package, or location information for identifying a packet in which the prompt package is transmitted, or a combination thereof. Here, the communication data may include broadcast data.

The transmission unit 260 may transmit the communication data generated by the package editing module 220. Here, the communication data may include multiple prompt packages and the additional indication information. The transmission unit 260 may transmit the communication data over the transport network 330 or the Internet.

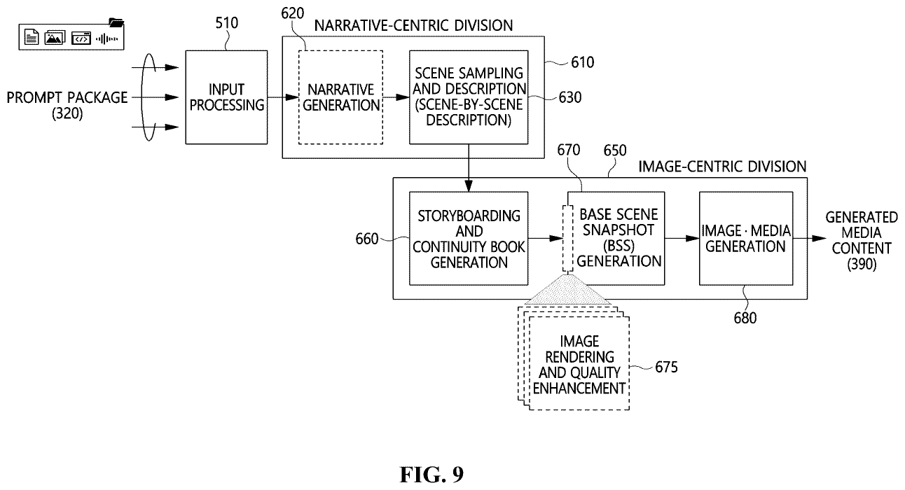

FIG. 9 is a diagram illustrating the configuration of a content generator according to an embodiment of the present disclosure.

Referring to FIG. 9, the CG 380 according to the present disclosure is a system which receives a prompt package 320 to generate media content. Here, the prompt package 320 may refer to a set of units into which semantic media sources for driving the PDM system 1 are grouped.

The “media content” described in the present disclosure includes, but is not limited to, image (video) content, audio content, pictures, and text content. The media content may include a haptic service, a service that provides scents and chemicals, a game service, etc., and may further include other types of services. That is, the media content may include at least one of image (video) content, audio content, pictures, text content, haptic service content, service content for providing chemicals, or game service content, or a combination thereof.

Meanwhile, the CG 380 according to the present disclosure may primarily perform a function of generating image content, with or without narrative content. Here, the image content may include the representation of both a moving image (motion picture or video) and a static image.

The CG 380 according to the present disclosure may generate image⋅media content, and may include a narrative generation unit 620, a scene sampling and description unit 630, a storyboarding and continuity control information (continuity book) generation unit 660, a Base Scene Snapshot (BSS) generation unit 670, and an image media generation unit 680.

The CG 380 according to the present disclosure may be composed of a narrative-centric function unit (division) 610 and an image-centric function unit (division) 650. The narrative-centric function unit 610 may include the narrative generation unit 620 and the scene sampling and description unit 630, and the image-centric function unit 650 may include the storyboarding and continuity book generation unit 660, the BSS generation unit 670, and the image⋅media generation unit 680. Meanwhile, a configuration in which all or part of the storyboarding and continuity book generation unit 660 is included in the narrative-centric function unit 610 may also be implemented.

A terminal 360 according to the present disclosure may include a receiver 370, an input processing unit 510, and the CG 380.

The input processing unit 510 may perform an operation of processing the prompt package 320 received by the receiver 370 into a format suitable for the input of the narrative generation unit 620. The input processing unit 510 may process the prompt package 320 into a format that can be recognized by the CG 380. The input processing unit 510 may process the prompt package 320 into a format for generating the media content 390.

The narrative generation unit 620 may perform an operation of generating the narrative of media content based on the information included in the prompt package 320. In other words, the narrative generation unit 620 may receive the prompt package information processed by the input processing unit 510, generate the narrative, and output the generated narrative. Here, the narrative may perform the role of describing the thematic progression and development of the media content to be ultimately generated.

The narrative generation unit 620 may produce the generated narrative at once, or may produce the generated narrative through a process of progressively refining the narrative in stages while outputting intermediate products (e.g., sketches, synopses, etc.).

The scene sampling and description unit 630 may extract a portion of the generated narrative to be converted into a key scene. That is, the scene sampling and description unit 630 may perform scene sampling. The scene sampling and description unit 630 may output a series of scene samples by receiving the generated narrative. Here, each scene sample describes a portion of the generated narrative, and one scene sample is a unit element to be subsequently implemented as a storyboard. An order is assigned to the scene samples.

The scene sampling and description unit 630 may provide a scene-by-scene description. The scene sampling and description unit 630 may perform re-editing for adding detailed elements or enhancing the completeness and specificity of the description, rather than generating scene samples by simply extracting a portion of the generated narrative.

The scene samples may be determined based on an event or an episode. A set of scene samples may include key scenes. Extracting scene samples in smaller segments, that is, extracting more scene samples from the portion of the generated narrative, may enhance the consistency and continuity of the content development in media content to be generated later, but it may also involve an increased computational load. In consideration of this, the so-called scene sampling frequency may be arbitrarily set.

The storyboarding and continuity book generation unit 660 may generate storyboard and continuity control information (continuity book) from the scene samples. Data output from the storyboarding and continuity book generation unit 660 may be configured in units of a storyboard and a continuity book. Alternatively, the storyboarding and continuity book generation unit 660 may generate the continuity book in a form included in the storyboard without generating the same in the form of separate data unit elements. A storyboard and a continuity book may be generated to be paired, and one or more storyboard-continuity book pairs may be extracted from a single scene sample.

Each storyboard functions to visualize a scene described in the corresponding scene sample, and may include elements such as rough sketches, scene layouts, inbetweens, keyframes, and the like. An order (sequence) may be assigned to storyboards and continuity books.

The BSS generation unit 670 may generate a scene image, that is, a BSS, from the storyboard and continuity book information. The BSS generation unit 670 may render BSS images based on sketch information of each storyboard and information about objects, background, and layout details of the storyboard, as well as continuity-related information such as object motion and camera movement represented in the corresponding continuity book. BSS may refer to a key scene to be stretched in an image (frame) sequence, and may have suitable quality as the input source image of image⋅media generation.

The BSS generation unit 670 may include an image rendering and quality enhancement unit 675 as a sub-function unit. Here, the image rendering and quality enhancement unit 675 performs a process of ultimately forming the image to have quality suitable for image media generation by starting at the storyboard, rendering an actual image, and then performing quality enhancement by stages. Here, a product derived from an intermediate process for quality enhancement is referred to as pre-BSS.

A combination of storyboard-continuity book forming a pair may derive one or more BSSs. If necessary, some storyboards may be excluded and not implemented as a BSS.

An order may be assigned to BSSs. The image⋅media generation unit 680 may generate ultimate media content by generating an image sequence from a series of BSSs and output the generated ultimate media content. An order may be assigned to image sequences, and may be related to presentation time during playback. In relation to the presentation of images, presentation time information may be separately recorded and output. This may function as a device that supports real-time characteristics, and the presentation time or related information may be processed and output into separate metadata, or may be output with the presentation time or related information added to an image sequence or unit data into which the image sequence is segmented.

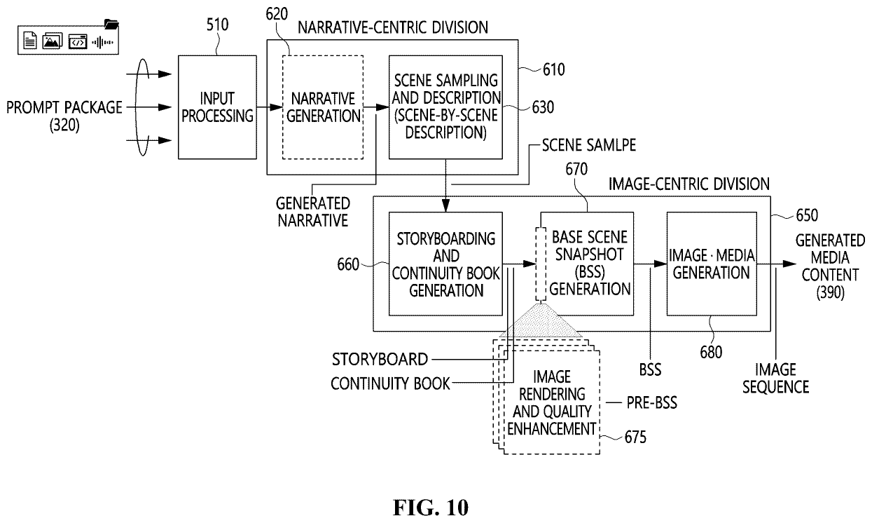

FIG. 10 is a diagram illustrating the configuration and output of a content generator according to an embodiment of the present disclosure.

Referring to FIG. 10, the CG 380 according to the present disclosure may design related elements to guarantee the continuity, consistency, and in-context coherence of generated content. In a piece of generated content, a basic storyline is primarily described in generated narrative, and thus narrative coherence, thematic consistency, and continuity may be maintained. For this, the generated narrative may function as a seed in a process of generating all by-products generated in the subsequent components of the CG 380. In consideration of the continuity and coherence of the generated content, individual components of the CG 380 may interact with preceding components. For this, connection channels between the components of the CG 380 may be taken into consideration. The continuity and coherence considered in the present disclosure may include semantic consistency and spatiotemporal connectivity.

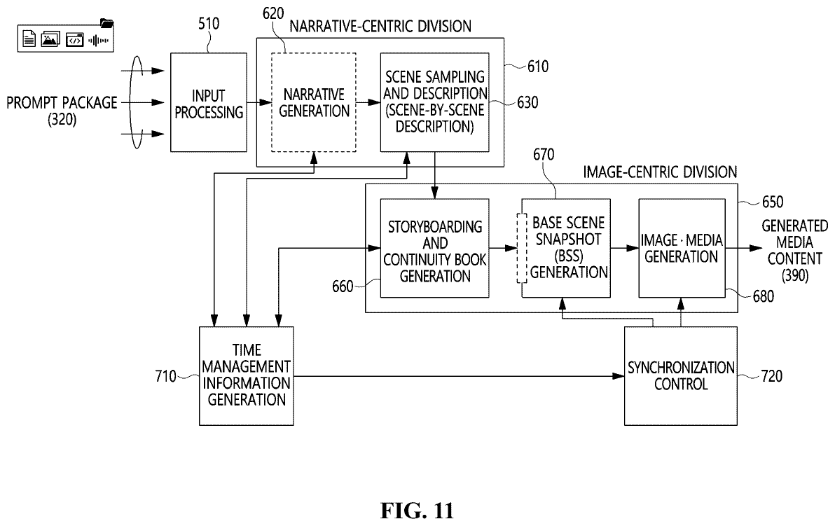

FIG. 11 is a diagram illustrating the configuration of a content generator according to another embodiment of the present disclosure.

Referring to FIG. 11, the CG 380 may further include a time management information generation unit 710 and a synchronization control unit 720. The time management information generation unit 710 and the synchronization control unit 720 are components included in the CG 380 to control synchronization of generated media content and presentation times for respective data units. The time management information generation unit 710 and the synchronization control unit 720 may perform functions related to synchronization and control of presentation times for respective data units.

The time management information generation unit 710 may adjust the temporal length or the like of each data unit, and may generate related control information and insert the control information. The time management information generation unit 710 may refer to the generated narrative, scene samples, storyboards, and continuity books, and may edit items related to time control of the corresponding data unit. For example, the time management information generation unit 710 may generate timestamp and length-related information of each scene, and may read and edit time control information previously inserted into input, the generated narrative, scene samples, storyboards, and continuity books. The time management information generation unit 710 may interact with the narrative generation unit 620, the scene sampling and description unit 630, the storyboarding and continuity book generation unit 660.

The synchronization control unit 720 may be a function unit that performs time control of products generated by the image media generation unit, and may receive related information from the time management information generation unit 710. The synchronization control unit 720 may deliver the control information to the BSS generation unit 670 and the image⋅media generation unit 680. The synchronization control unit 720 may insert timestamp or presentation time information, and may function as a device that supports real-time characteristics of the generated content.

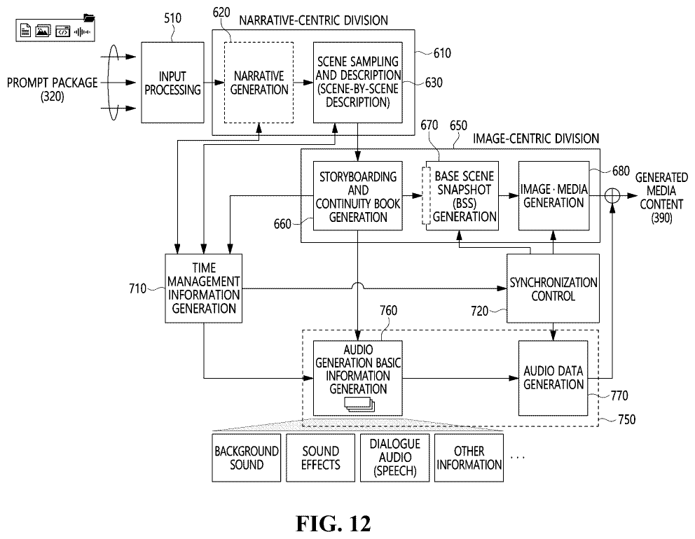

FIG. 12 is a diagram illustrating the configuration of a content generator according to a further embodiment of the present disclosure.

Referring to FIG. 12, the CG 380 according to the present disclosure is an image (video) content generation system including generation of audio data. The CG 380 according to the present disclosure may generate media content configured through a combination of an image and audio. Audio may be generated either simultaneously with an image in a state coupled to the image by a generative model trained in an associated manner, or separately by a dedicated function unit.

The audio data of the generated content may be internally generated, together with the image, by the components illustrated in FIG. 9 or 11, and the CG 380 may further include a separate audio data processing unit 750. The audio data processing unit 750 may include an audio generation basic information generation unit 760 and an audio data generation unit 770. That is, the CG 380 according to the present disclosure may further include the audio generation basic information generation unit 760 and the audio data generation unit 770. The CG system 380 illustrated in FIG. 9 may be extended, as illustrated in FIG. 12. In FIG. 12, the audio generation basic information generation unit 760 and the audio data generation unit 770 are additionally defined.

The audio generation basic information generation unit 760 may receive the output of the storyboarding and continuity book generation unit 660, and may generate intermediate data required for generating audio data. The audio data to be generated may include background sound, sound effects, speech, and other forms. For example, the audio generation basic information generation unit 760 may output each character's dialogue, the character's vocal style, and other features. The audio generation basic information generation unit 760 may output indication information for controlling the length of audio data to be generated, with reference to the time control information from the time management information generation unit 710. That is, the audio generation basic information generation unit 760 may generate the indication information for controlling the length of the audio data to be generated based on the time control information from the time management information generation unit 710.

Here, the generation of the basic information for audio generation may refer to scene samples or the generated narrative. That is, the audio generation basic information generation unit 760 may generate the basic information for audio generation based on the scene samples or the generated narrative, and may output the generated basic information for audio generation.

The audio data generation unit 770 may receive the output of the audio generation basic information generation unit 760 and then generate the ultimate audio data. The length and time of the generated audio data may be controlled with reference to the indication information of the audio generation basic information generation unit 760 or the time control information of the time management information generation unit 710. That is, the audio data generation unit 770 may control the length and time of the audio data based on the indication information output from the audio generation basic information generation unit 760 or the time control information output from the time management information generation unit 710.

The synchronization control unit 720 may receive the time control information of the time management information generation unit 710 to control synchronization between an image sequence and the audio data.

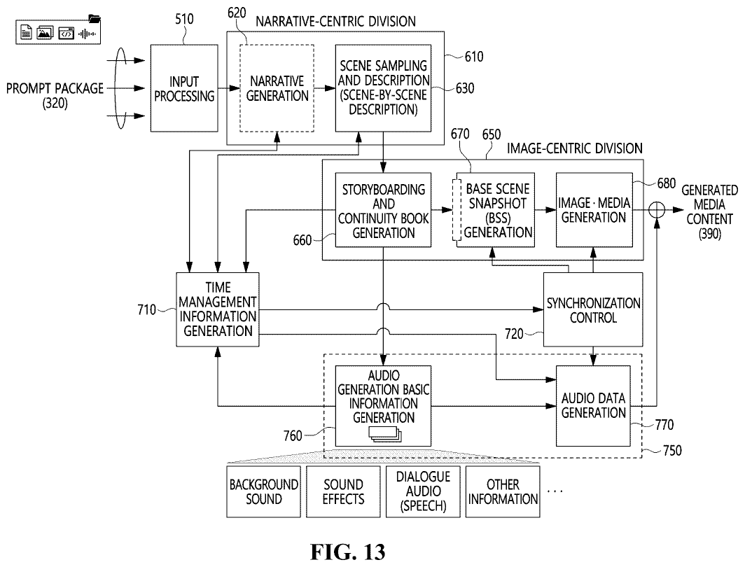

FIG. 13 is a diagram illustrating the configuration of a content generator according to yet another embodiment of the present disclosure.

Referring to FIG. 13, the CG 380 including the separate audio data processing unit 750 may be configured, as illustrated in FIG. 13, in addition to FIG. 12. The design of FIG. 13 is configured such that the time management information generation unit 710 may generate time control information by additionally referring to the output of the audio generation basic information generation unit 760, and may deliver the time control information to the audio data generation unit 770.

The CG 380 according to the present disclosure may receive separate additional data, in addition to the received prompt package.

Hereinafter, the structure and definition of generated data in media content generation will be described.

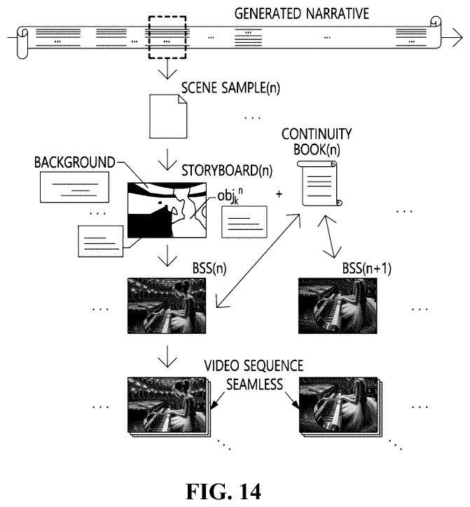

FIG. 14 is a diagram illustrating a process in which BSS is generated according to an embodiment of the present disclosure.

Referring to FIG. 14, relationships between the outputs (e.g., generated narrative, scene samples, storyboards, continuity books, BSSs, image (video) sequences, etc.) of respective components of the CG 380 according to the present disclosure may be represented by the example illustrated in FIG. 14. The example of FIG. 14 shows the case where a pair of storyboard and continuity book is generated from a single scene sample and a single BSS is generated from a single storyboard-continuity book pair.

The concepts and features of the outputs (e.g., generated narrative, scene samples, storyboards, continuity books, BSSs, and video sequences) of respective components may be described as follows. A series of scene samples, a series of storyboards and continuity books, and a series of BSSs are generated from the generated narrative, and a series of video sequences is ultimately produced therefrom.

Each scene sample, storyboard, continuity book, and BSS form a sequence, and a scene sample, a storyboard, a continuity book, and a BSS, which correspond to each unit, are assigned an identifier that specifies the order information of the corresponding unit data within the sequence. For example, an order index may be assigned as follows. A scene sample having an n-th index may be denoted as scene sample (n). A storyboard having an n-th index may be denoted as storyboard(n). A continuity book having an n-th index may be denoted as continuity book(n). A BSS having an n-th index may be denoted as BSS (n).

The generated narrative is a component that describes the thematic progression and development of media content to be ultimately generated. Generally, a single piece of completed generated media content is derived from a single generated narrative, but there may be exceptional cases. The generated narrative may be formed in the form of text, and may embrace other formats and modalities. Information of other modalities or additional information may be described in a form coupled to indication information about the location of internal data within the generated narrative.

A scene sample is a description data unit derived from a portion of the generated narrative, and each scene sample includes a depiction of one scene. Each storyboard is a unit dataset that visualizes the scene depicted in the corresponding scene sample, and may include elements such as rough sketches, scene layouts, inbetweens, and keyframes. Each storyboard may include information about objects and background elements, which constitute each scene, and arrangements, characteristics, and features thereof. Such information may take the form of sketch images or supplementary data appended to data corresponding thereto. In this case, tagging or pointers may be used for the positional coordinates of elements within the sketch images or data corresponding thereto. Each storyboard may include an access link (i.e., access point) and an interface for an interactivity function and arrangement information thereof. Each storyboard may include indication information for a scene mood or style. Each storyboard may contain annotations concerning other additional information.

Each continuity book is a description data unit generated to be paired with the corresponding storyboard, and includes information for the continuity, consistency, and coherence of scenes. Each continuity book may include information about the movement of each object, the movement of a view angle, the movement of a camera focus, etc., and may be described in association with the subsequent scenes and storyboards. For example, a new object objkⁿ⁺¹ may appear in a scene immediately following the scene described in storyboard(n), and may then enter the frame of the scene. Here, continuity book(n) may describe the movement information of the object objkⁿ⁺¹ in association with storyboard(n) and storyboard(n+1).

The continuity book may contain timestamp or time-related indication information. A method for generating the continuity book in a form included in a storyboard without generating the continuity book as a separate data unit element may also be implemented.

A single continuity book may be associated with one or more storyboards. The fact that certain storyboard(ns) and continuity Book(nc) are associated with each other may be explicitly indicated, and for this indication, a header, a pointer or the like may be used. A single continuity book may be associated with one or more BSSs.

BSS refers to a key scene to be stretched in an image (frame) sequence and has suitable quality as the input source image of image⋅media generation. Each BSS may include information about objects and background elements, which constitute a scene, and the features, interactivity function, access point, etc. thereof in the form of supplementary data, and may also include information about positional coordinates which correspond to respective objects, background elements, and features, interactivity function, and access point thereof, within the scene data, together with the supplementary data. Each BSS may include annotations for a scene mood, style information, and other additional information. Each BSS may include indication information representing (one or more) associated continuity books.

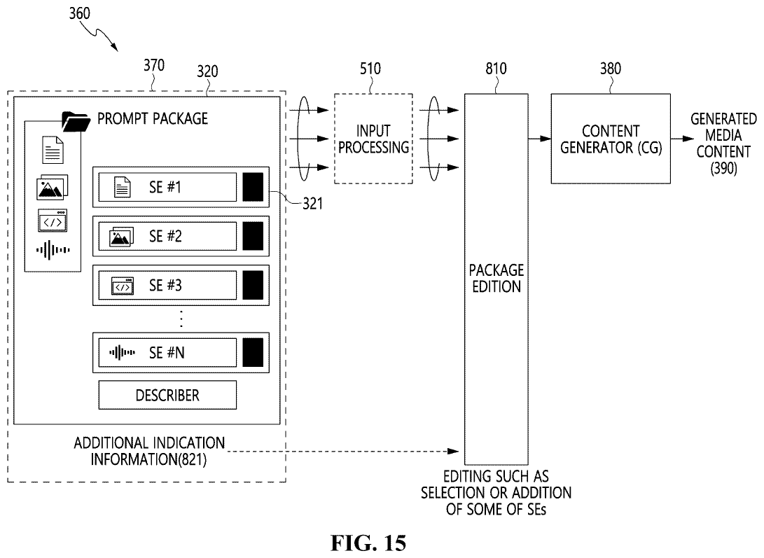

FIG. 15 is a diagram illustrating the configuration of a terminal according to an embodiment of the present disclosure.

Referring to FIG. 15, the terminal 360 according to the present disclosure may include a receiver 370, an input processing unit 510, a package editing module 810, and a CG 380. Here, the terminal 360 may include an electronic device including a processor for processing data, a computer, a notebook, a television, an automotive display apparatus, or an equipment display apparatus including another form of a vehicle, and a mobile electronic apparatus such as a smartphone or an electronic pad.

The receiver 370 may receive communication data containing one or more prompt packages 320 and additional indication information 821. Functions of the input processing unit 510 and the CG 380 have been described above. Here, the additional indication information 821 may include at least one of identification information for identifying each prompt package, type information, grade information, or presentation time schedule information of the prompt package, or location information for identifying a packet in which the prompt package is transmitted, or a combination thereof.

The package editing module 810 may be coupled to the input stage (front end) of the CG 380. The package editing module 810 may perform a function of processing multiple prompt packages and extending a supplementary service. The present disclosure may provide, in a content generator (CG) system which receives semantic media sources through the package editing module 810 and generates media content, a function system that adjusts the output service of the CG 380 by editing and modifying each received prompt package 320 and the operation of the function system. Here, the prompt package 320 may be a set unit of semantic media source data designed to generate a piece of completed media content. Each prompt package 320 may be composed of one or more Service Elements (SEs) 321, and examples of a structure related to the prompt package 320 have been described above.

That is, the Generative Receiver Terminal (GRT) 360 according to the present disclosure may perform a function that is capable of editing, modifying and processing an input prompt package before a process of generating media content.

The package editing module 810 is characterized in the function of editing and processing the components of the input prompt package 320. This includes a function of leaving only some of the SEs 321 and associated data thereof in the input prompt package 320 and excluding the remaining portions thereof. This function may be performed depending on the rule based on SE additional information designated for each SE in the prompt package 320. For example, the package editing module 810 may repackage the prompt package 320 by leaving only arbitrary K SEs having higher priority based on priority information designated for each SE in the prompt package 320, and may deliver the repackaged prompt package 320 to the CG 380. In addition, the package editing module 810 may edit the corresponding prompt package based on separate additional indication information 821, as illustrated in FIG. 15. The package editing module 810 includes the function of repackaging the input prompt package 320 by adding additional data and SEs to the input prompt package 320.

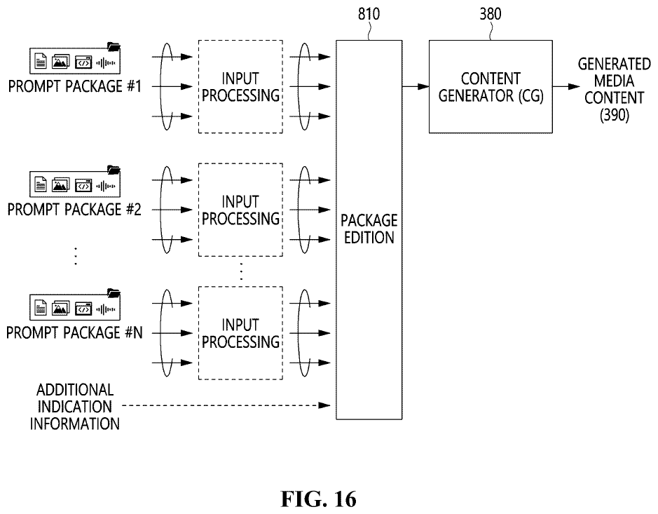

FIG. 16 is a diagram illustrating an operation in which a terminal according to an embodiment of the present disclosure processes multiple prompt package inputs. FIG. 16 is a block diagram illustrating an operation in which the terminal according to the present disclosure processes synchronized multiple prompt package inputs.

Referring to FIG. 16, the package editing module 810 may include a function of processing synchronized multiple prompt package inputs. Here, the operation of the terminal 360 which processes synchronized multiple prompt package inputs refers to an operation of deriving a single piece of generated content from multiple prompt packages.

The package editing module 810 may designate a main prompt and sub-prompts among the input prompt packages, and may deliver the designated prompts to the CG 380. The main prompt refers to a prompt package functioning as a main semantic source element in generated content, and the sub-prompts refer to prompt packages, functioning as sub-source elements, other than the main prompt. In this case, differentiated grades may be assigned to the sub-prompts.

Depending on whether the corresponding prompt package is a main prompt or a sub-prompt or depending on the grade of the prompt, the number of SEs to be utilized may differ. Also, the determination of SEs functioning as a background element, a main character, key objects or primary narrative indication information may be influenced by whether a specific prompt package is a main prompt or a sub-prompt or by the assigned prompt grade.

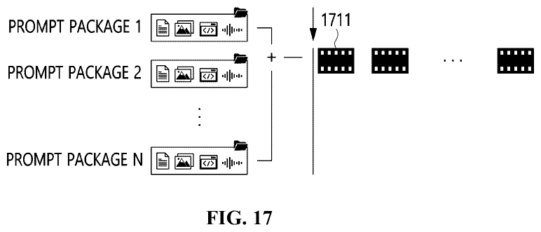

FIG. 17 is a diagram for explaining a function of generating a single piece of media content from synchronized multiple prompt package inputs illustrated in FIG. 16.

Referring to FIG. 17, a single piece of media content 1711 may be generated from synchronized multiple prompt package inputs. That is, the terminal 360 may generate the single piece of media content 1711 from the synchronized multiple prompt package inputs.

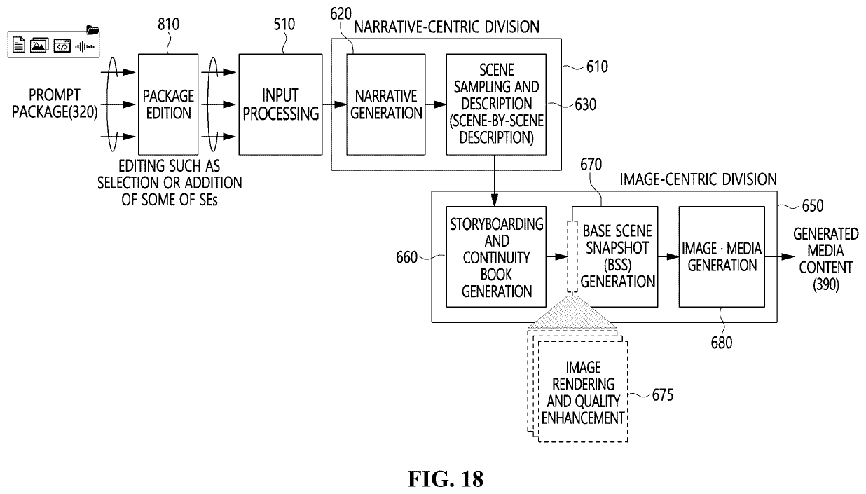

FIG. 18 is a diagram illustrating the configuration of a terminal according to another embodiment of the present disclosure.

Referring to FIG. 18, when a service for generating image media is taken into consideration, the structure of the terminal illustrated in FIG. 15 may be specified, as illustrated in FIG. 18. FIG. 18 shows the entire system structure including the detailed structure of the CG 380 for generating image media, and the input processing unit 510. In FIG. 18, the input processing unit 510 is arranged in the output stage (rear end) of the package editing module 810.

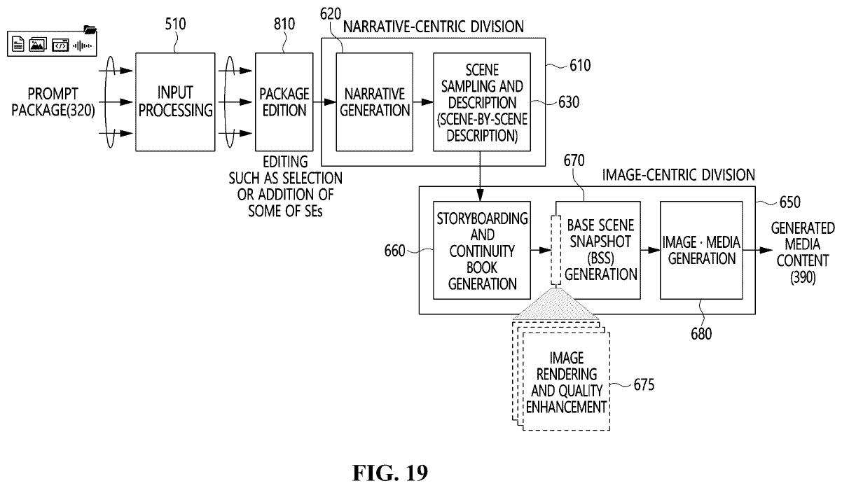

FIG. 19 is a diagram illustrating the configuration of a terminal according to a further embodiment of the present disclosure.

Referring to FIG. 19, when a service for generating image media is taken into consideration, the structure of the terminal illustrated in FIG. 15 may be specified, as illustrated in FIG. 19. FIG. 19 shows the entire system structure including the detailed structure of the CG 380 for generating image media, and the input processing unit 510. In FIG. 19, the input processing unit 510 is arranged in the input stage (front end) of the package editing module 810.

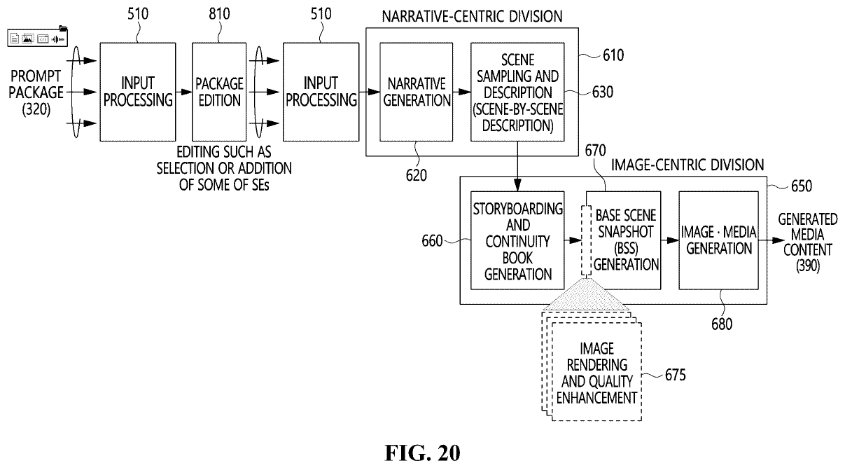

FIG. 20 is a diagram illustrating the configuration of a terminal according to yet another embodiment of the present disclosure.

Referring to FIG. 20, when a service for generating image media is taken into consideration, the structure of the terminal illustrated in FIG. 15 may be specified, as illustrated in FIG. 20. FIG. 20 shows the entire system structure including the detailed structure of the CG 380 for generating image media, and input processing units 510. In FIG. 20, the input processing units 510 are arranged in input and output stages (front and rear ends) of the package editing module 810.

The entire system may be subdivided, as shown in FIGS. 18, 19, and 20, depending on the location at which a package editing function is performed. In FIG. 18, after package editing is performed on the input prompt package 320, input processing is undergone, and the result of input processing is delivered to the CG 380. In FIG. 19, after input processing is first performed on the received prompt packages 320, package editing is undergone, and the result of package editing is delivered to the CG 380. In FIG. 20, after input processing is performed on the received prompt packages 320, package editing is performed. Thereafter, input processing is performed again on the result of the package editing, and the result of the input processing is delivered to the CG 380.

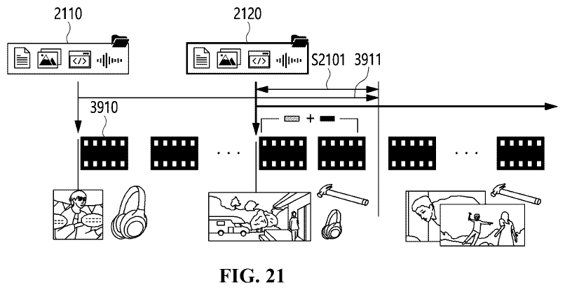

FIG. 21 is a diagram conceptually illustrating a situation in which multiple prompt packages are asynchronously input.

Referring to FIG. 21, the terminal 360 according to the present disclosure may generate seamless media content from multiple prompt packages 2110 and 2120 which are asynchronously input.

The present disclosure provides the CG 380 and a method of operating the CG 380, which generate media content consecutive to media content 3910 that is already being generated by reflecting the multiple prompt packages 2110 and 2120 in the media content 3910 when the multiple prompt packages 2110 and 2120 are asynchronously input to the CG 380. The representation “asynchronous input of multiple prompt packages” described in the present disclosure refers to a situation S2101 in which another prompt package 2120 is input at a time point at which the media content 3910, derived from the specific prompt package 2110, is already being generated. The present disclosure may provide a system and method that perform a function of combining the remaining portion 3911 (i.e., a portion that is not yet generated or presented) of the media content 3910 that is already being generated with the element of the newly input prompt package 2120 and consecutively generating media content, in the situation S2101.

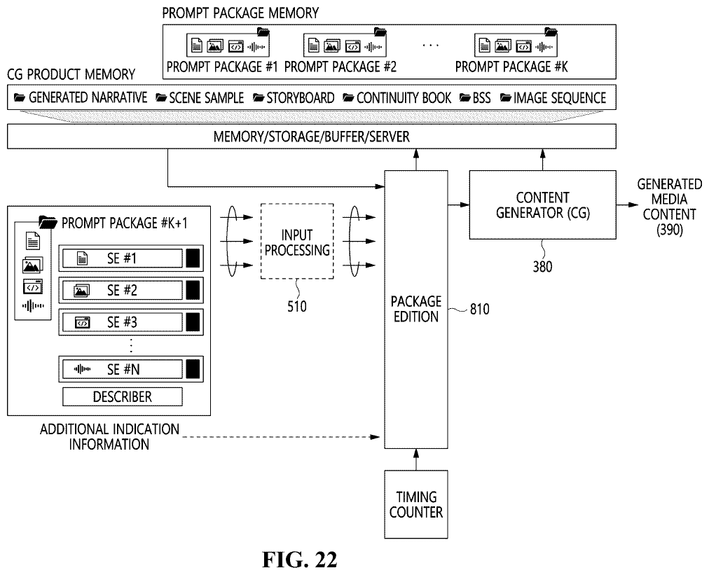

FIG. 22 is a diagram illustrating the configuration of a terminal according to still another embodiment of the present disclosure.

Referring to FIG. 22, the terminal 360 takes a structure of inputting a newly input prompt package #K+1, together with a prompt package corresponding to content currently being generated and CG products, to the package editing module 810, repackaging the prompt packages and re-inputting the repackaged result to the CG 380.

Therefore, the terminal 360 according to the present disclosure may include a memory unit for prompt packages and CG products, and an access interface and a channel for the memory unit.

The operation of repackaging and re-inputting to the CG 380 by the terminal 360 may be described as follows. For example, prompt package P2 may be received at a time point at which the generation and output of media content for prompt package P1 is progressing. For simplicity of description, it is assumed that generated content data derived from prompt package P by a CG operation of generating content based on a single prompt package is C(P|OS), generated content data derived from a set SP of prompt packages by a CG operation of generating content based on synchronized multiple prompt package inputs is C(SP|OM1), and generated content data derived from the set SP of prompt packages by a CG operation of generating content based on unsynchronized multiple prompt package inputs is C(SP|OM2).

Here, the CG operation of generating content based on the single prompt package is referred to as OS, the CG operation of generating content based on synchronized multiple prompt package inputs is referred to as OM1, and the CG operation of generating content based on the unsynchronized multiple prompt package inputs is referred to as OM2.

In the case where multiple services (which are units in which prompt packages are defined) are combined with each other using the OM2 method when prompt package P2 is received at a time point at which the generation and output of media content for prompt package P1 is progressing, the CG 380 may generate and output media content by combining prompt package P2 (or a portion thereof) with a portion of C(P1|OS) that is not yet generated, instead of delaying the output of C(P2|OS) to the time after a time point at which the output of C(P1|OS) is terminated and of generating C(P2|OS) separately from C(P1|OS). Here, pieces of associated data corresponding to the portion of C(P1|OS) that is not yet generated are called R(P1^{c}). R(P1^{c}) collectively refers to data including pieces of data, such as generated narrative, scene samples, storyboards, continuity books, and BSSs, derived from P1 using the OS method.

The generated media content output from the CG 380 may be output in the form of data segmented into units. This unit may be an image (video) sequence frame, a certain unit of segments, or other units. Each unit (hereinafter referred to as a segment) may contain presentation time scheduling, and additional time information for time-related schedule control. In association with this, each of generated narrative, scene samples, storyboards, continuity books, BSSs, etc. may contain time-related information or order information.

When the OM2 method is applied, the CG may find the development position within the corresponding BSS, storyboard, scene sample or generated narrative by inversely tracking the time/sequential position of the currently output image frame C(P1|OS). As illustrated in FIG. 22, this may be conducted by allowing the package editing module 810 or the CG 380 to access memory/storage/buffer/server.

In case that the OM2 method is applied, the CG 380 may apply OM1 to R(P1c) U P2, that is, a union of R(P1c) and P2. This may be performed using a method of processing R(P1c) and P2 into two independent prompt packages and inputting the prompt packages to the package editing module 810 or a method functionally similar to the method.

Accordingly, the CG 380 may output new content C(R(P1c)∪P2|OM1) in which the element of P2 is mixed during the output of content C(P1|OS), that is, from the middle of content development of content C(P1|OS).

The terminal 360 may manage the presentation time schedule of the generated content. For example, time schedules intended by P1 and P2, respectively, may be different from each other. Only portions of runtime plans of the two services may overlap each other. For example, P1 may be scheduled to be presented during a period [t0, t0+2T] and P2 may be scheduled to be presented during a period [t0+T, t0+3T]. In this case, generated content derived from R(P1c)∪P2 is continuously presented during a period [t0+T, t0+2T], after which content derived from P2 may be generated and presented during a period [t0+2T, t0+3T].

In relation to the time scheduling, setting of a main prompt and sub-prompts may be used. Each BSS may have a timestamp, which may be associated with the time information of derived image frames. By means of this, storyboard-based (segmented) time schedules may be known. For example, in the example of a time schedule, when [t0+T, t0+2T] corresponds to a time segment {τni, . . . , τnf}, [t0+T, t0+2T] and the time segment {τni, . . . , τnf} may correspond to service elements related to the scene sample {Sk1, . . . , SK11} of R(P1c) and the flag point {NI1, . . . , NL11} of the generated narrative. During the period [t0, t0+2T], P1 may have priority. In this case, during the period [t0+T, t0+2T], R(P1c) in R(P1c)∪P2 may be designated as a main prompt, P2 may be designated as a sub-prompt, and the designated prompts may be utilized in the CG. Thereafter, during the period [t0+2T, t0+3T], P2 may be designated as the main prompt and utilized in the CG.

The example may be specified as follows. Assuming that P1 is an advertisement for product G1 and P2 is an advertisement for product G2, only product G1 appears in C(P1|OS) presented during a period [t0, t0+T], products G1 and G2 appear together in C(R(P1c)∪P2|OM1) presented during a period [t0+T, t0+2T], and product G1 disappears in content presented during a period [t0+2T, t0+3T].

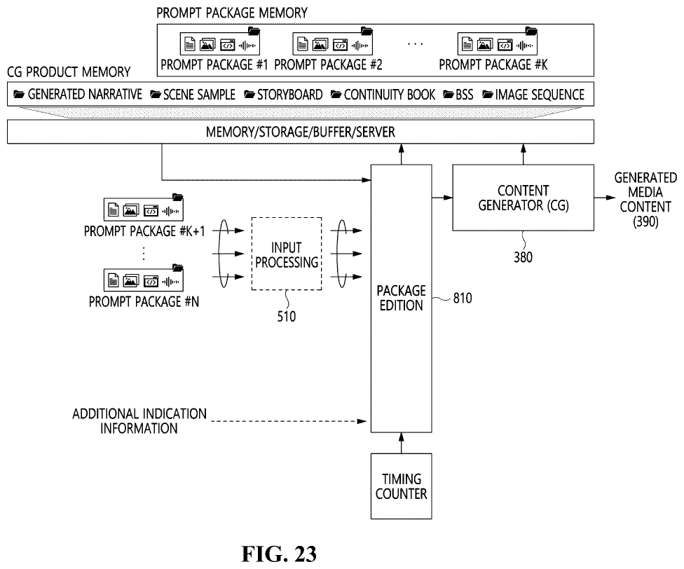

FIG. 23 is a diagram illustrating the configuration of a terminal according to still another embodiment of the present disclosure.

Referring to FIG. 23, a system structure for the case where the number of newly input prompt packages is two or more may be designed, as illustrated in FIG. 23, by extending the structure of FIG. 22.

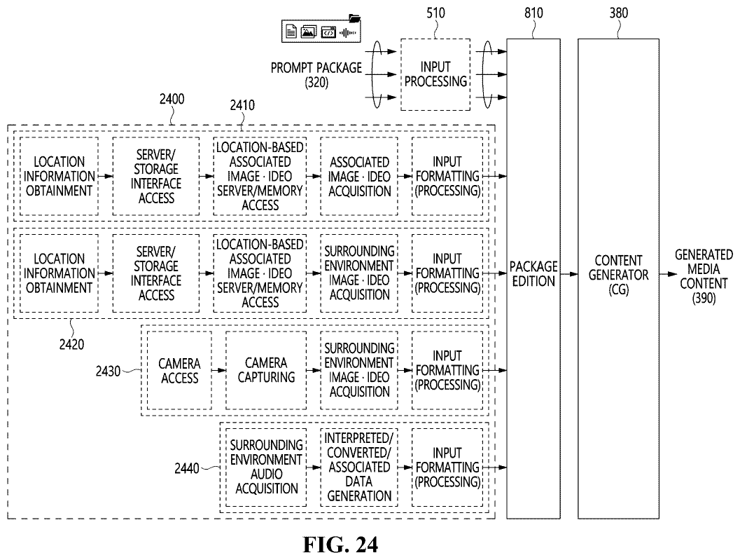

FIG. 24 is a diagram illustrating the configuration of a terminal according to still another embodiment of the present disclosure.

Referring to FIG. 24, the terminal 360 according to the present disclosure may collect surrounding environment data and utilize the collected data for the generation of media content. The terminal 360 may collect the surrounding environment data of a user and reflect the collected data in generated media content.

The terminal 360 may obtain the location information of the user, acquire image or video information of the surrounding environment of the corresponding location based on the location information, and generate media content 390 in which such surrounding environment image or video information is reflected. In this case, reflecting the surrounding environment image or video information may include the case where the background of the surrounding environment becomes the background of the generated content, or where a major building or object located around the location of the user appears in the generated content.

The terminal 360 may obtain the location information of the user, acquire data associated with the corresponding location based on the location information, and generate media content 390 in which such associated data is reflected.

The terminal 360 may access a camera to obtain captured data, acquire image or video information of the surrounding environment of GRT based on the captured data, and generate media content 390 in which such surrounding environment image or video information is reflected.

The terminal 360 may obtain audio information of the surrounding environment using a microphone or the like, interpret the surrounding environment audio information, convert the interpreted surrounding environment audio information, or generate associated data related to the surrounding environment audio information, and generate media content 390 in which at least one of the converted surrounding environment audio information, the generated associated data, or data derived from the associated data, or a combination thereof is reflected. Here, reflecting the information or data derived from the audio information may include the case where, when audio has speech information having a meaning, the speech information is interpreted, content or an object associated with the interpreted information appears in the generated content, the case where, when audio contains specific music information, a human or an object related to the music information appears in the generated content, and other cases.

The terminal 360 may further include a surrounding environment data processing unit 2400. The surrounding environment data processing unit 2400 may obtain the location information of the user, and may acquire content based on the obtained location information. The package editing module 810 may edit the prompt package 320 so that the content acquired by the surrounding environment data processing unit 2400 is composited into the scene of the media content 390.

The surrounding environment data processing unit 2400 may include first to fourth surrounding environment data processing units 2410, 2420, 2430, and 2440.

The first surrounding environment data processing unit 2410 may obtain the location information of the user, acquire associated data at the corresponding location based on the location information, and format the acquired associated data into the form of SE.

The second surrounding environment data processing unit 2420 may obtain the location information of the user, acquire surrounding environment image or video information at the corresponding location based on the location information, and format the surrounding environment image or video information into the form of SE.

The third surrounding environment data processing unit 2430 may access the camera to acquire captured data, acquire the surrounding environment image or video information of GRT based on the captured data, and form the acquired surrounding environment image or video information into the form of SE.

The fourth surrounding environment data processing unit 2440 may obtain audio information of a surrounding environment using a microphone or the like, interpret the surrounding environment audio information, convert the interpreted surrounding environment audio information, or generate associated data related to the surrounding environment audio information, and format at least one of the converted surrounding environment audio information, the generated associated data, or data derived from the associated data, or a combination thereof into the form of SE.

The package editing module 810 may combine the information formatted into the form of SE by the surrounding environment data processing unit 2400 with the prompt package 320, and may edit or process the combined prompt package and deliver the same to the CG 380. Here, only one of the first to fourth surrounding environment data processing units 2410, 2420, 2430, and 2440 may be selectively operated, or some of them may be operated in combination.

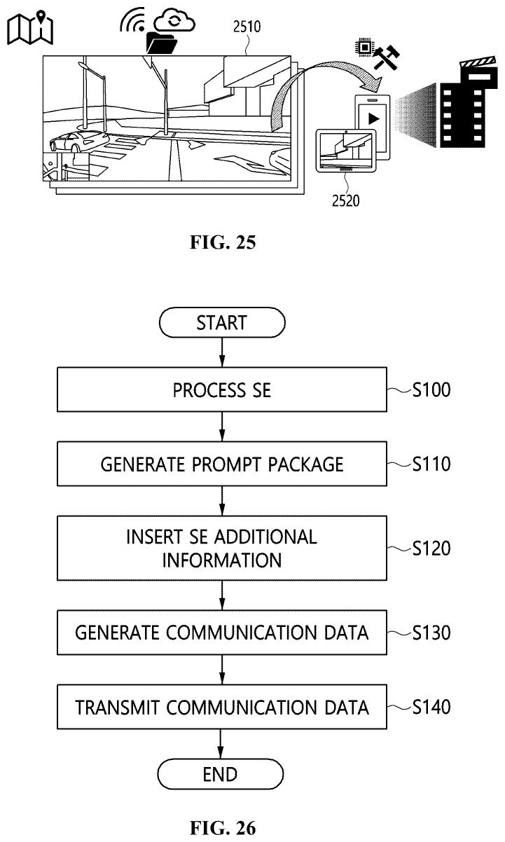

FIG. 25 is a diagram conceptually illustrating an example in which the surrounding environment of a user appears as the background of generated image content.

Referring to FIG. 25, a user's surrounding environment 2510 appears as the background of generated image content 2520 in an embodiment of the present disclosure. In the embodiment of the present disclosure, advertisement content presented on the terminal 360 may also express real-world background 2510, as viewed from a location corresponding to the current time point, as the background in the content 2520.

FIG. 26 is a flowchart illustrating a process in which a method for transmitting communication data for media content generation is performed according to an embodiment of the present disclosure.

Referring to FIG. 26, the SE processing unit 210 processes SEs based on an input media source at step S100. Here, the media source may include at least one of a text file, an image file, a video file, an audio file, a program file, a layout data file between objects, or an application program interface (API) data file, or a combination thereof. Here, the text file may include at least one of data indicating an instruction or a command described in the form of text, data indicating content synopsis described in the form of text, or data indicating novel content described in the form of text, or a combination thereof.

The package editing module 220 generates a prompt package including the SEs processed by the SE processing unit 210 at step S110. At step S110, the package editing module 220 may generate the prompt package by sorting and selecting some of SEs processed by the SE processing unit 210 and adding SEs, and may process the generated prompt package. The package editing module 220 may generate the prompt package in the structures of FIGS. 5 to 7.

The additional information processing unit 230 inserts SE additional information into the prompt package generated by the package editing module 220 at step S120. Here, the SE additional information may include at least one of priority information of each SE, information describing the characteristics of the SE, timing information related to a time point at which the SE appears within the media content, relationship indication information indicating correlations between the SE and other SEs, usage indication information indicating correlations in terms of utilization and application between the SE and other SEs, or SE link information, or a combination thereof.

The additional information processing unit 230 generates communication data including one or more prompt packages and additional indication information at step S130. Here, the additional indication information may include at least one of identification information for identifying each prompt package, type information, grade information, time management information, or presentation time schedule information of the prompt package, or location information for identifying a packet in which the prompt package is transmitted, or a combination thereof. Here, the communication data may include broadcast data.

The transmission unit 260 transmits the communication data generated by the package editing module 220 at step S140. Here, the communication data may include multiple prompt packages and the additional indication information. At step S140, the transmission unit 260 may transmit the communication data over the transport network 330 or the Internet.

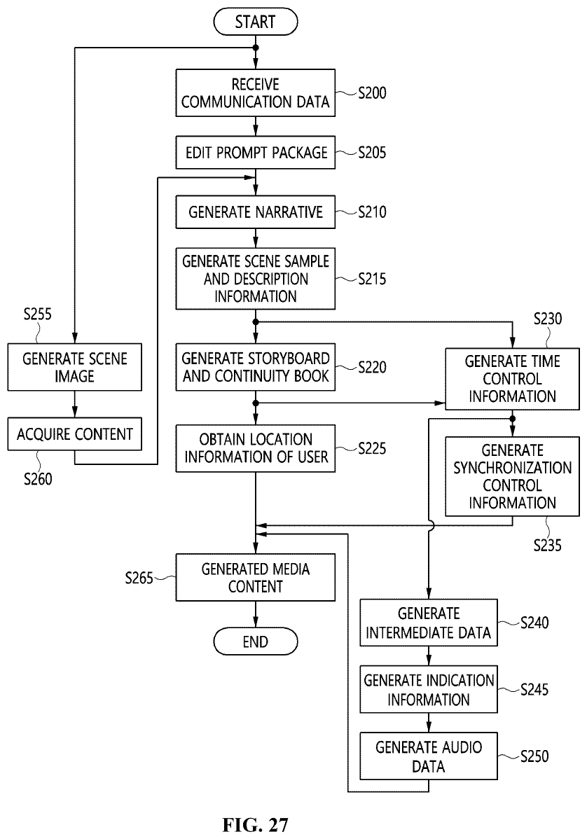

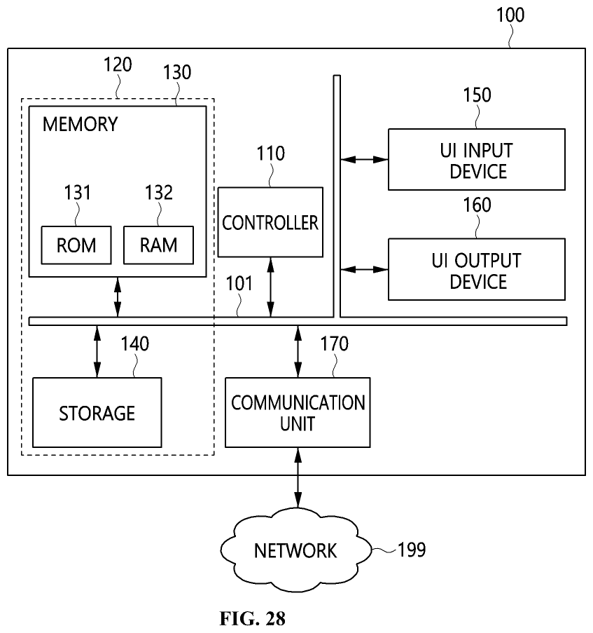

FIG. 27 is a flowchart illustrating a process in which a method for receiving communication data for media content generation is performed according to an embodiment of the present disclosure.

Referring to FIG. 27, the receiver 370 receives communication data including a prompt package for media content generation at step S200. Here, the media content may include at least one of image (video) content, audio content, pictures, text content, haptic service content, service content for providing chemicals, or game service content, or a combination thereof. The communication data may include multiple prompt packages and the additional indication information. The additional indication information may include at least one of identification information for identifying each prompt package, type information, grade information, or presentation time schedule information of the prompt package, or location information for identifying a packet in which the prompt package is transmitted, or a combination thereof. The communication data may include broadcast data.

The package editing module 810 extracts the prompt package from the communication data, received at step S200, at step S205. At step S205, the package editing module 810 may extract additional indication information from the communication data, and may extract a first prompt package and a second prompt package from the communication data based on the extracted additional indication information.

At step S205, the package editing module 810 may edit or process each extracted prompt package.

In some embodiments, at step S205, the input processing unit 510 may process the prompt package, edited or processed by the package editing module 810, into a format that can be recognized by the content generator 380.

The narrative generation unit 620 generates the narrative of the media content based on the prompt package at step S210.

The scene sampling and description unit 630 extracts a portion to be converted into a scene from the narrative generated at step S210, generates a scene sample depicting the scene and description information of the scene sample at step S215. The storyboarding and continuity book generation unit 660 generates a storyboard including at least one of sketch information, object information, background information or layout information of each scene, or a combination thereof from the scene sample and description information, generated at step S215, and a continuity book including at least one of objection motion information or camera movement information of the scene, or a combination thereof at step S220. At step S220, the storyboarding and continuity book generation unit 660 may generate the storyboard and the continuity book based further on time control information generated at step S230.

The Base Scene Snapshot (BSS) generation unit 670 generates a scene image from the storyboard and the continuity book, generated at step S220, at step S225. At step S225, the BSS generation unit 670 generates a composite scene by combining a partial scene of the media content generated based on the second prompt package edited at step S205 with a partial scene of the media content, generated based on the first prompt package edited at step S205.

The time management information generation unit 710 generates time control information based on the narrative, generated at step S210, and the scene sample, generated at step S215, at step S230. At step S230, the time management information generation unit 710 may correct the generated time control information based on the storyboard and continuity book generated at step S220.

The synchronization control unit 720 generates synchronization control information for controlling an image (video) sequence from the time control information, generated at step S230, at step S235.

The audio generation basic information generation unit 760 generates intermediate data for audio data from the storyboard and the continuity book, generated at step S220, at step S240.

The audio generation basic information generation unit 760 generates indication information required for controlling the length of the audio data based on the time control information, generated at step S230, at step S245.

The audio data generation unit 770 generates audio data based on the intermediate data, generated at step S240, and the indication information, generated at step S245, at step S250. Here, the audio data to be generated may include at least one of background sound, sound effects or speech, or a combination thereof.

The surrounding environment data processing unit 2400 obtains the location information of the user at step S255.

The surrounding environment data processing unit 2400 acquires content based on the location information, obtained at step S255, at step S260. The content acquired at step S260 may be an image, video or audio of a surrounding environment, and may be an image, video or audio associated with the surrounding environment. At step S205, the package editing module 810 may edit the prompt package so that the content acquired at step S260 is composited into the scene of the media content generated at step S265.

The image⋅media generation unit 680 generates media content by generating an image sequence from the scene image, generated at step S225, at step S265. At step S265, the image media generation unit 680 may correct the image sequence based on the synchronization control information generated at step S235. Furthermore, at step S265, the image⋅media generation unit 680 may synchronize the image sequence with the audio data, generated at step S250, based on the synchronization control information generated at step S235.

FIG. 28 is a diagram illustrating the configuration of a computer system according to an embodiment of the present disclosure.

Referring to FIG. 28, each of the transmitter 10 according to the present disclosure and the terminal 360 according to the present disclosure may be implemented in a computer system 100 such as a computer-readable storage medium.

The computer system 100 may include a bus 101, a controller 110, a storage unit 120, a user interface (UI) input device 150, a UI output device 160, and a communication unit 170. The storage unit 120 may include memory 130 and storage 140. The controller 110, the memory 130, the storage 140, the UI input device 150, the UI output device 160, and the communication unit 170 may communicate with each other through the bus 101.

When the transmitter 10 is implemented in the computer system 100, the UI input device 150 may receive media sources from a user or another device, and the storage unit 120 may store the input media sources, SEs, and prompt packages. Also, the controller 110 may perform functions of the package formatting unit 200. The communication unit 170 may perform functions of the transmission unit 260.

When the terminal 360 is implemented in the computer system 100, the UI output device 160 may output generated media content 390, and the storage unit 120 may store the received prompt packages, generated narrative, scene samples, storyboards, continuity books, BSSs, and image (video) sequences. Further, the controller 110 may perform functions of the input processing unit 510, the package editing module 810, the CG 380, and the surrounding environment data processing unit 2400. The communication unit 170 may perform functions of the receiver 370.

The controller 110 may be a semiconductor device which executes processing instructions stored in the storage unit 120. The controller 110 may be at least one hardware processor. The controller 110 may be composed of one or more cores, and may include processors for data analysis and deep learning, such as a Central Processing Unit (CPU), a Graphics Processing Unit (GPU), a Digital Signal Processor (DSP), an Application Specific Integrated Circuit (ASIC), a general purpose graphics processing unit (GPGPU), and a Tensor Processing Unit (TPU). The controller 110 may perform data processing to train a deep learning network according to an embodiment of the present disclosure by reading a computer program stored in the storage unit 120.

Program modules may be implemented using instructions or codes that are executed by at least one processor of the controller 110. The program modules may be included in the computer system 100 in the form of an operating system, an application module, and other program modules. The program modules may be physically stored in various known storage devices. Further, at least some of the program modules may be stored in a remote storage device capable of communicating with the communication unit 170.

The controller 110 may execute the instructions or codes of components, units or modules described in embodiments.

The storage 140 may be a storage medium that includes at least one of a nonvolatile medium, a removable medium, a non-removable medium, a communication medium, or an information delivery medium, or a combination thereof.

The memory 130 may include Read Only Memory (ROM) 131 or Random Access Memory (RAM) 132.

The communication unit 170 may transmit/receive data to/from other devices over a network 199. Here, the network 199 may be a broadcasting network, a private network or the Internet, and may include a wired network or a wireless network. The network 199 may refer to one or more parts of a network that can be an ad hoc network, intranet, extranet, Bluetooth, ZigBee, Virtual Private Network (VPN), Local Area Network (LAN), Wireless LAN (IEEE 802.11b, IEEE 802.11a, IEEE 802.11g, IEEE 802.11n), Wireless Broadband (WiBro), Wide Area Network (WAN), Wireless WAN (WWAN), Metropolitan Area Network (MAN), the Internet, a portion of the Internet, a portion of a Public Switched Telephone Network (PSTN), a Plain Old Telephone Service (POTS) network, a cellular telephone network, a wireless network, a Wi-Fi® network, other types of networks, or any combination of two or more of such networks. Further, the network 199 may also refer to one or more parts of a network that is connected to other types of networks. For example, the network or a part of the network may include a wireless or cellular network, and connection may be Code Division Multiple Access (CDMA) connection, Global System for Mobile communications (GSM) connection, or other types of cellular or wireless connections. In this example, connection may be implemented using any of various types of data transmission technologies, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation (4G) wireless networks, Universal Mobile Telecommunications System (UMTS), High Speed Packet Access (HSPA), Worldwide Interoperability for Microwave Access (WiMAX), Long Term Evolution (LTE) standards, other technologies defined by various standard-setup organizations, other long-distance protocols, or other data transmission technologies.

In the above-described embodiments, when applying specific processing to a specific target, a specific condition may be required. In the case where it is described that the specific processing is performed under a specific determination, when it is described that the determination of whether the specific condition is satisfied is made based on a specific coding parameter, or that a specific determination is made based on a specific coding parameter, such coding parameters may be construed as being replaceable with other coding parameters. In other words, the coding parameter influencing the specific condition or the specific determination may be regarded as being exemplary, and it may be understood that combinations of one or more other coding parameters in addition to the specified coding parameter perform the function of the specified coding parameter.

In the above-described embodiments, although the methods have been described as a series of steps or units, based on flowcharts, the present disclosure is not limited by the order of the steps, and some steps may occur as steps different from the above-described steps or in an order different from that of the above-described steps, or simultaneously with the above-described steps. Further, those skilled in the art will understand that the steps shown in the flowchart are not exclusive, and that other steps may be included, or one or more of the steps in the flowchart may be omitted without departing from the scope of the present disclosure.

The above-described embodiments include examples in various aspects. Although not all possible combinations for indicating various aspects can be described, those skilled in the art will recognize that additional combinations other than the explicitly described combinations are possible. Therefore, it may be appreciated that the present disclosure includes all other replacements, changes, and modifications belonging to the accompanying claims.

The above-described embodiments of the present disclosure may be implemented in the form of program instructions that can be executed through various computer components and may be recorded in a computer-readable storage medium. The computer-readable storage medium may include program instructions, data files, and data structures, either solely or in combination. The program instructions recorded on the computer-readable storage medium may be specifically designed and configured for the present disclosure, or may be disclosed and available to those skilled in computer software fields.

The computer-readable storage medium may include information used in embodiments according to the present disclosure. For example, the computer-readable storage medium may include a bitstream, and the bitstream may include information described in embodiments of the present disclosure.

The bitstream may include computer-executable code and/or program. The computer-executable code and/or program may include pieces of information described in the embodiments, and may include syntax elements described in the embodiments. In other words, the pieces of information and syntax elements described in the embodiments may be regarded as a computer-readable code in the bitstream, and may be regarded as at least part of the computer-executable code and/or program represented by the bitstream.

The computer-readable storage medium may include a non-transitory computer-readable medium.

Examples of the computer-readable storage medium include hardware devices specially configured to store and execute program instructions, such as magnetic media, such as a hard disk, a floppy disk, and magnetic tape, optical media, such as compact disk (CD)-ROM and a digital versatile disk (DVD), magneto-optical media, such as a floptical disk, ROM, RAM, and flash memory. Examples of program instructions include not only machine language code created by a compiler but also high-level language code that can be executed by a computer using an interpreter or the like. The foregoing hardware devices may be configured to operate as one or more software modules in order to perform processing according to the present disclosure, and vice versa.

According to the transmitter, media system, and method for transmitting communication data for media content generation, the amount of communication data transmitted can be effectively decreased compared to a conventional media system by transmitting a prompt package for media content generation. Also, a broadcasting terminal can generate individual pieces of user-customized content, thus improving each user's satisfaction with the broadcast content. Further, media content that concretizes a function of media generation and that stabilize the quality of generated content through structured prompts can be generated.

According to the terminal, system, and method for receiving communication data for media content generation, the amount of communication data received can be effectively decreased compared to a conventional media system by transmitting a prompt package for media content generation. Also, a broadcasting terminal can generate individual pieces of user-customized content, thus improving each user's satisfaction with the broadcast content. Further, media content that concretizes a function of media generation and that stabilize the quality of generated content through structured prompts can be generated, and media content can also be generated in consideration of the user's surrounding environment.

While the present disclosure has been described above with reference to specific details such as detailed components, limited embodiments, and drawings, these have been provided merely for the purpose of facilitating a more comprehensive understanding of the disclosure. The present disclosure is not limited to the above-described embodiments, and those skilled in the art to which the present disclosure pertains can make various changes and modifications based on the description thereof.

Accordingly, the spirit of the present disclosure should not be construed as being limited to the described embodiments, and all modifications and variations that are made equally or equivalently to the accompanying claims may fall within the scope of the spirit of the present disclosure.

What is claimed is:

1. A method for receiving broadcast data for media content generation, comprising:
receiving broadcast data including a prompt package for generating media content; and
generating media content based on the received prompt package.

2. The method of claim 1, wherein the media content includes at least one of image content, audio content, a picture, text content, haptic service content, service content for providing chemicals, or game service content.

3. The method of claim 1, wherein generating the media content comprises:
generating a narrative of the media content based on the received prompt package;
extracting a portion of the narrative to be converted into a scene and then generating a scene sample depicting the scene and description information of the scene sample;
generating time control information based on the narrative and the scene sample;
generating, from the scene sample and the description information, a storyboard including at least one of sketch information, object information, background information, or layout information of the scene and a continuity book including at least one of objection motion information, or camera movement information of the scene;
generating a scene image from the storyboard and the continuity book;
generating synchronization control information for controlling an image sequence from the time control information; and
generating the image sequence from the scene image, and then generating the media content by synchronizing the image sequence based on the synchronization control information.

4. The method of claim 3, further comprising:
generating intermediate data for audio data from the storyboard and the continuity book;
generating indication information for controlling a length of the audio data based on the time control information; and
generating the audio data based on the generated intermediate data and the generated indication information.

5. The method of claim 4, wherein the audio data includes at least one of a background sound, sound effects, or speech.

6. The method of claim 1, further comprising:
processing the received prompt package into a format for generating the media content.

7. The method of claim 1, wherein the broadcast data further includes additional indication information including at least one of identification information for identifying the prompt package, type information, grade information, or presentation time schedule information of the prompt package, or location information for identifying a packet in which the prompt package is transmitted.

8. The method of claim 7, further comprising:
extracting a first prompt package and a second prompt package from the broadcast data based on the additional indication information,
wherein generating the media content comprises:
generating a composite scene by combining a partial scene of media content generated based on the second prompt package with a partial scene of media content generated based on the first prompt package.

9. The method of claim 8, wherein generating the composite scene comprises:
generating the composite scene based on the presentation time schedule information.

10. The method of claim 1, further comprising:
obtaining location information of a user;
acquiring content based on the location information; and
editing the prompt package such that the acquired content is composited into a scene of the media content.

11. A terminal for receiving broadcast data for media content generation, comprising:
a receiver configured to receive broadcast data including a prompt package for generating media content; and
a content generator configured to generate the media content based on the received prompt package.

12. The terminal of claim 11, wherein the media content includes at least one of image content, audio content, a picture, text content, haptic service content, service content for providing chemicals, or game service content.

13. The terminal of claim 11, wherein the content generator comprises:
a narrative generation unit configured to generate a narrative of the media content based on the received prompt package;
a scene sampling and description unit configured to extract a portion of the narrative to be converted into a scene and then generate a scene sample depicting the scene and description information of the scene sample;
a storyboarding and continuity book generation unit configured to generate, from the scene sample and the description information, a storyboard including at least one of sketch information, object information, background information, or layout information of the scene and a continuity book including at least one of objection motion information, or camera movement information of the scene;
a Base Scene Snapshot (BSS) generation unit configured to generate a scene image from the storyboard and the continuity book;
an image media generation unit configured to generate the media content by generating an image sequence from the scene image;
a time management information generation unit configured to generate time control information based on the narrative and the scene sample; and
a synchronization control unit configured to generate synchronization control information for controlling synchronization of the image sequence based on the time control information.

14. The terminal of claim 13, further comprising:
an audio generation basic information generation unit configured to generate intermediate data for audio data from the storyboard and the continuity book and generate indication information for controlling a length of the audio data based on the time control information; and
an audio data generation unit configured to generate the audio data based on the generated intermediate data and the generated indication information.

15. The terminal of claim 11, further comprising:
an input processing unit configured to process the received prompt package into a format that is recognizable by the content generator.

16. The terminal of claim 11, wherein the broadcast data further includes additional indication information including at least one of identification information for identifying the prompt package, type information, grade information, or presentation time schedule information of the prompt package, or location information for identifying a packet in which the prompt package is transmitted.

17. The terminal of claim 16, further comprising:
a package editing module configured to extract a first prompt package and a second prompt package from the broadcast data based on the additional indication information,
wherein the content generator generates a composite scene by combining a partial scene of media content generated based on the second prompt package with a partial scene of media content generated based on the first prompt package.

18. The terminal of claim 17, wherein the content generator generates the composite scene based on the presentation time schedule information.

19. The terminal of claim 11, further comprising:
a surrounding environment data processing unit configured to obtain location information of a user and acquire content based on the location information, wherein the package editing module edits the prompt package so that the acquired content is composited into a scene of the media content.

20. A broadcasting system for receiving broadcast data for media content generation, comprising:
a terminal configured to receive broadcast data including a prompt package for generating media content, and transmit a message requesting media content including the received prompt package; and
a content generator configured to receive the message, generate the media content based on the prompt package included in the message, and transmit the generated media content to the terminal.
